(19) United States
(12) Patent Application Publication
(10) Pub. No.: US 2026/0094374 A1
(43) Pub. Date: Apr. 2, 2026

(54) HIGH-FIDELITY 3D MESH GENERATION VIA NEURAL NETWORKS

(71) Applicant: NVIDIA Corporation, Santa Clara, CA (US)

(72) Inventors: Ming-Yu Liu, Redwood City, CA (US); David Wilson Romero Guzman, Amsterdam, CA (US); Zekun Hao, New York, NY (US); Tsung-Yi Lin, Sunnyvale, CA (US)

(21) Appl. No.: 19/330,018

(22) Filed: Sep. 16, 2025

Related U.S. Application Data
(60) Provisional application No. 63/702,594, filed on Oct. 2, 2024.

(51) Int. Cl. G06T 17/20; G06N 3/045; G06N 3/08

(52) U.S. Cl. CPC G06T 17/20; G06N 3/045; G06N 3/08

(57) ABSTRACT

Apparatuses, systems, and techniques to generate a 3D mesh using one or more neural networks. In at least one embodiment, tokens of a sequence of tokens that represents a sequence of coordinates of vertices of polygons of a polygon mesh are generated autoregressively using one or more neural networks based on a 3D representation of an object and one or more attributes. In at least one embodiment, the sequence of tokens includes start-of-part and end-of-part tokens that separate vertex coordinates corresponding to a part of the 3D representation of the object. In at least one embodiment, the one or more neural networks are trained via a progressive training technique that employs iterative vocabulary expansion and fine-tuning.

### CLAIM OF PRIORITY

This application claims the benefit of U.S. Provisional Application No. 63/702,594, titled “Meshtron: High-Fidelity, Artist-Like 3d Mesh Generation At Scale” and filed Oct. 2, 2024, the entire contents of which are incorporated herein by reference.

### BACKGROUND

Meshes are one of the most important and widely used representations of 3D assets. Meshes are the de facto standard in the film, design, and gaming industries and are natively supported by virtually all 3D software and graphics hardware. While meshes can be generated automatically by 3D reconstruction software algorithms, high-quality meshes suitable for games and movies—i.e., those that can be manipulated, articulated, and animated—are almost exclusively created by artists. Artist-created meshes not only capture the external appearance of objects but also their intrinsic properties and construction details. However, creation of the intricate details of the mesh topology and the specific tessellation of vertices and faces—which are crucial for efficient editing, rendering, and artifact-free animation—is a labor-intensive task that requires significant time of artists with expertise in 3D modelling. Automation of such tasks would free artists to focus on more creative aspects of 3D modeling and broaden access to high-quality 3D content by much larger audiences.

In recent years, generative neural networks, such as autoregressive Large Language Models (LLMs) and Diffusion Models, have advanced to the point where generated data is often indistinguishable from real examples. However, direct generation of 3D meshes remains a challenge due to the scarcity of high-quality training data, the complexity required to properly represent 3D assets via meshes, and the size of the resulting 3D meshes. Generative neural networks that directly generate 3D meshes have been successful for low face-count meshes but have not been sufficiently scalable to generate detailed, realistic shapes—which often require more than 10,000 faces. Consequently, most generative neural networks for 3D assets rely on alternative 3D representations such as Neural Radiance Fields (NeRFs), 3D Gaussians, Sparse Voxel Grids (SVGs), or point clouds. However, such alternative 3D representations are typically converted into meshes for use in real-world applications. Unfortunately, the conversion process—which frequently results in over-smoothed geometries and complex, uninformative mesh topologies-limits the usability of such AI-generated 3D assets.

### BRIEF DESCRIPTION OF THE DRAWINGS

Subject matter of the present disclosure is described in detail below with reference to the attached drawing figures. Features described and/or illustrated herein can be used alone and/or combined in different combinations. The attached drawings illustrate the following:

FIG. 1A provides a framework for generating a 3D mesh, in accordance with an embodiment;

FIG. 1B illustrates a block diagram of a system for generating a 3D mesh, in accordance with an embodiment;

FIG. 1C illustrates a neural network architecture for a mesh generating model, in accordance with an embodiment;

FIG. 1D illustrates an example architecture for a conditioned mesh generating model, in accordance with an embodiment;

FIG. 2A illustrates a flowchart of a method 200 for generating a 3D mesh, in accordance with an embodiment;

FIG. 2B illustrates a flowchart of a method for generating a token sequence for a 3D mesh via a part-by-part procedure, in accordance with an embodiment;

FIG. 3A illustrates a flowchart of a method for training a mesh generating model to generate a 3D mesh, in accordance with an embodiment;

FIGS. 3B, 3C, and 3D illustrate representing a triangle of a 3D triangle mesh with different levels of quantization;

FIG. 3E illustrates a flowchart of a method for training a mesh generating model to generate a 3D mesh, in accordance with an embodiment;

FIG. 4 illustrates an example parallel processing unit suitable for use in implementing one or more embodiments;

FIG. 5A is a conceptual diagram of a processing system, implemented using the PPU of FIG. 4, suitable for use in implementing one or more embodiments;

FIG. 5B illustrates an exemplary system in which the various architecture and/or functionality of the various previous embodiments may be implemented;

FIG. 5C illustrates components of an exemplary system that can be used to train and utilize machine learning, suitable for use in implementing one or more embodiments; and

FIG. 6 illustrates an exemplary streaming system suitable for use in implementing one or more embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

The systems and methods described herein may be used by, without limitation, non-autonomous vehicles, semi-autonomous vehicles (e.g., in one or more advanced driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. Further, the systems and methods described herein may be used for a variety of purposes, by way of example and without limitation, for machine control, machine locomotion, machine driving, synthetic data generation, model training or updating, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, generative AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medical systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing generative AI operations, systems implemented using large language models (LLMs), systems implemented using vision language models (VLMs), systems for performing light transport simulation, systems for performing collaborative content creation for 3D assets, systems implemented at least partially using cloud computing resources, and/or other types of systems.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or at least one model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring).

The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

According to one or more embodiments, an autoregressive mesh generation model is provided. In at least one embodiment, the autoregressive mesh generation model is able to generate meshes with up to 64K faces at 1024-level coordinate resolution. In at least one embodiment, the autoregressive mesh generation model has an Hourglass Transformer architecture. In at least one embodiment, the autoregressive mesh generation model is trained via truncated sequence training. In at least one embodiment, the autoregressive mesh generation model generates meshes via sliding window inference. In at least one embodiment, the autoregressive mesh generation model employs a robust sampling strategy that enforces orders of mesh sequences.

According to one or more embodiments, an autoregressive mesh generation model transforms input data into a 3D mesh based on input data to be transformed and one or more learned attributes to be reproduced. In at least one embodiment, the autoregressive mesh generation model is trained to generate a mesh having attributes of a 3D object by using a curated set of training objects in which one or more attributes are present. In at least one embodiment, the autoregressive mesh generation model is trained by first encoding a training set of objects (for example, a set of curated meshes having desired attributes) to remove desired attributes and then training the autoregressive mesh generation model to reconstruct desired attributes using the encoded training set as input data and original objects (i.e., having the desire attributes) as ground truth.

According to one or more embodiments, an autoregressive mesh generation model is trained via a training process that includes a pre-training step in which training sets are ended into tokens in a latent space. In at least one embodiment, rather than encoding tokens, embeddings are used and input training data is normalized to have values between −1 and 1. In at least one embodiment, normalized input training data is split into bins through quantization. In at least one embodiment, a quantization process results in generating embeddings in training data. In at least one embodiment, all coordinates of a mesh are in a continuous space, and these coordinates are normalized to fall within the range of −1 to 1.

According to one or more embodiments, an autoregressive mesh generation model utilizes a latent space discretized into a specified number of bins. In at least one embodiment, the autoregressive mesh generation model is trained to predict positions of mesh coordinates within the specified number of bins. In at least one embodiment, the autoregressive mesh generation model handles continuous values by predicting their discrete counterparts within defined bins. In at least one embodiment, the autoregressive mesh generation model utilizes embeddings derived from quantization of continuous input values.

According to one or more embodiments, an autoregressive mesh generation model is trained via progressive training at different spatial resolutions. In at least one embodiment, the progressive training includes performing multiple iterations of vocabulary expansion, each followed by a fine-tuning process. In at least one embodiment, the progressive training includes training a first autoregressive mesh generation model to predict positions of mesh coordinates within a first specified number of bins, increasing the number of bins to a second specified number of bins, and fine tuning a modified first autoregressive mesh generation model to predict positions of mesh coordinates within the second specified number of bins.

According to one or more embodiments, an autoregressive mesh generation model accepts pre-generated meshes or mesh related data as input and generates a 3D mesh having trained features as output. In at least one embodiment, the autoregressive mesh generation model generates 3D meshes having desired attributes such as a determined amount of symmetry, a specified number of polygons, a specified polygon density, a specified polygon shape (e.g., triangle polygons or quadrilateral polygons), and/or a specified ratio of polygon shapes (e.g., a ratio of triangle polygons to quadrilateral polygons).

According to one or more embodiments, an autoregressive mesh generation model generates a 3D mesh by transforming input data into a set of tokens that represent vertices of polygons of the 3D mesh. In at least one embodiment, the autoregressive mesh generation model generates the 3D mesh by predicting a set of tokens that represent faces of polygons of the 3D mesh. In at least one embodiment, each token representing a face of a polygon is represented as a vector that is decoded into vertices and coordinates for mesh rendering. In at least one embodiment, the autoregressive mesh generation model predicts nine tokens per polygon of the mesh, each of the nine tokens representing a coordinates of a vertex of the respective polygon. In at least one embodiment, the autoregressive mesh generation model predicts three tokens per polygon of the mesh, each of the three tokens representing a vertex of the respective polygon. In at least one embodiment, the autoregressive mesh generation model predicts one token per polygon of the mesh, each token representing a face of the respective polygon. In at least one embodiment, the autoregressive mesh generation model encodes input data into a latent space representing polygon faces, and the polygon faces inferred by the autoregressive mesh generation model are decoded into polygon coordinates that can be rendered.

According to one or more embodiments, an autoregressive mesh generation model generates a 3D mesh via part-based ordering. In at least one embodiment, the autoregressive mesh generation model generates a complete 3D mesh for one part of an n-part object, then generates a complete 3D mesh for a second part of the n-part object, then generates complete 3D meshes for the remaining n−2 parts of the n-part object, one part at a time. In at least one embodiment, the autoregressive mesh generation model generates one or more start-of-part tokens at the beginning of the process of generating each part of the n-part object and generates one or more end-of-part tokens at the end of the process of generating each part.

According to one or more embodiments, a first system includes one or more processors to use one or more neural networks to generate a sequence of tokens that represent vertex coordinates of a 3D mesh based, at least in part, on one or more three-dimensional representations of one or more objects, and one or more memories to store the one or more neural networks. The 3D mesh comprises one or more parts, and the sequence of tokens includes a set of start-of-part tokens and a set of end-of-part tokens that designate a start and an end of a set of tokens that represent vertex coordinates of a respective part of the one or more parts.

According to at least one embodiment of the first system, the one or more three-dimensional representations of the one or more objects are one or more of a point cloud, a three-dimensional mesh, Neural Radiance Fields (NeRF), Signed Distance Function (SDF) and a gaussian 3D models.

According to at least one embodiment of the first system, the one or more neural networks comprise an Hourglass Transformer backbone. According to at least one embodiment, the Hourglass Transformer backbone comprises a plurality of transformer stacks, one or more shortening layers, and one or more upsampling layers.

According to at least one embodiment of the first system, the sequence of tokens has a length of N, the 3D mesh is formed of a plurality of n-dimensional polygons, a first shortening layer is configured to reduce a sequence length of a first token sequence processed by a corresponding transformer stack from 3nN to 3N, and a second shortening layer is configured to reduce a sequence length of a second token sequence processed by a corresponding transformer stack from 3N to N.

According to at least one embodiment of the first system, a first transformer stack of the plurality of transformer stacks is configured to process vertex coordinate tokens that each designate a coordinate of a vertex of a polygon of the 3D mesh, a second transformer stack of the plurality of transformer stacks is configured to process vertex tokens that each designate a vertex of a polygon of the 3D mesh, and a third transformer stack of the plurality of transformer stacks is configured to process polygon tokens that each represent a polygon of the 3D mesh.

According to at least one embodiment of the first system, each transformer stack is configured to receive a conditional embedding corresponding to the one or more three-dimensional representations of the one or more objects. According to at least one embodiment, the conditional embedding received by each respective transformer stack is provided to at least one cross-attention layer of the respective transformer stack.

According to one or more embodiments, a first method is provided for generating, by one or more neural networks, a sequence of tokens that represent vertices of a 3D mesh based, at least in part, on one or more three-dimensional representations of one or more objects. The method further includes generating, for each respective part of one or more parts of the one or more objects, a respective token sequence, each respective token sequence comprising one or more start-of-part tokens, one or more vertex coordinate tokens, and one or more end-of-part tokens. Each of the one or more vertex coordinate tokens represents a coordinate of a vertex of the respective part.

According to at least one embodiment of the first method, the one or more neural networks comprise an Hourglass Transformer backbone comprising a plurality of transformer stacks, one or more shortening layers, and one or more upsampling layers.

According to one or more embodiments, a second system includes one or more processors to use one or more neural networks to generate a sequence of tokens that represent vertex coordinates of a 3D mesh based, at least in part, on one or more three-dimensional representations of one or more objects and one or more memories to store the one or more neural networks. The one or more neural networks are trained via a progressive training process that includes providing a pretrained transformer backbone, expanding one or more parameter blocks of the pretrained transformer backbone to provide an expanded transformer backbone, and fine-tuning the expanded transformer backbone to provide the one or more neural networks.

According to at least one embodiment of the second system, the pretrained transformer backbone is an Hourglass Transformer backbone.

According to at least one embodiment of the second system, expanding the one or more parameter blocks of the pretrained transformer backbone comprises expanding a weight matrix of a final linear layer of the pretrained transformer backbone, the final linear layer being configured to project embeddings in a hidden space of transformer blocks of the pretrained transformer backbone into a logits space.

According to at least one embodiment of the second system, the progressive training further comprising initializing one or more weights of the expanded transformer backbone with weights of the pretrained transformer backbone.

According to at least one embodiment of the second system, the one or more three-dimensional representations include one or more of a point cloud, a 3D mesh, a Neural Radiance Fields (NeRF), a Signed Distance Function (SDF), or a 3D Gaussian model.

According to at least one embodiment of the second system, the Hourglass Transformer backbone comprises a plurality of transformer stacks, one or more shortening layers, and one or more upsampling layers.

According to at least one embodiment of the second system, the sequence of tokens has a length of N, wherein the 3D mesh is formed of a plurality of n-dimensional polygons, a first shortening layer is configured to reduce a sequence length of a first token sequence processed by a corresponding transformer stack from 3nN to 3N, and a second shortening layer is configured to reduce a sequence length of a second token sequence processed by a corresponding transformer stack from 3N to N.

According to at least one embodiment of the second system, a first transformer stack of the plurality of transformer stacks is configured to process vertex coordinate tokens that each designate a coordinate of a vertex of a polygon of the 3D mesh, a second transformer stack of the plurality of transformer stacks is configured to process vertex tokens that each designate a vertex of a polygon of the 3D mesh, and a third transformer stack of the plurality of transformer stacks is configured to process polygon tokens that each represent a polygon of the 3D mesh.

According to one or more embodiments, a second method is provided for training one or more neural networks to generate a sequence of tokens that represent vertices of a 3D mesh based, at least in part, on one or more three-dimensional representations of one or more objects. The second method includes providing a pretrained transformer backbone, expanding one or more parameter blocks of the pretrained transformer backbone to provide an expanded transformer backbone, and fine-tuning the expanded transformer backbone to provide the one or more neural networks.

According to at least one embodiment of the second method, the one or more neural networks comprise an Hourglass Transformer backbone comprising a plurality of transformer stacks, one or more shortening layers, and one or more upsampling layers.

More illustrative information will now be set forth regarding various optional architectures and features. It should be strongly noted that the following information is set forth for illustrative purposes and should not be construed as limiting in any manner. Any of the following features may be optionally incorporated with or without the exclusion of other features described.

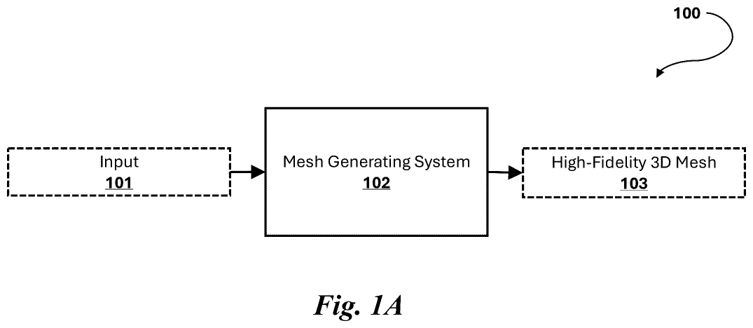

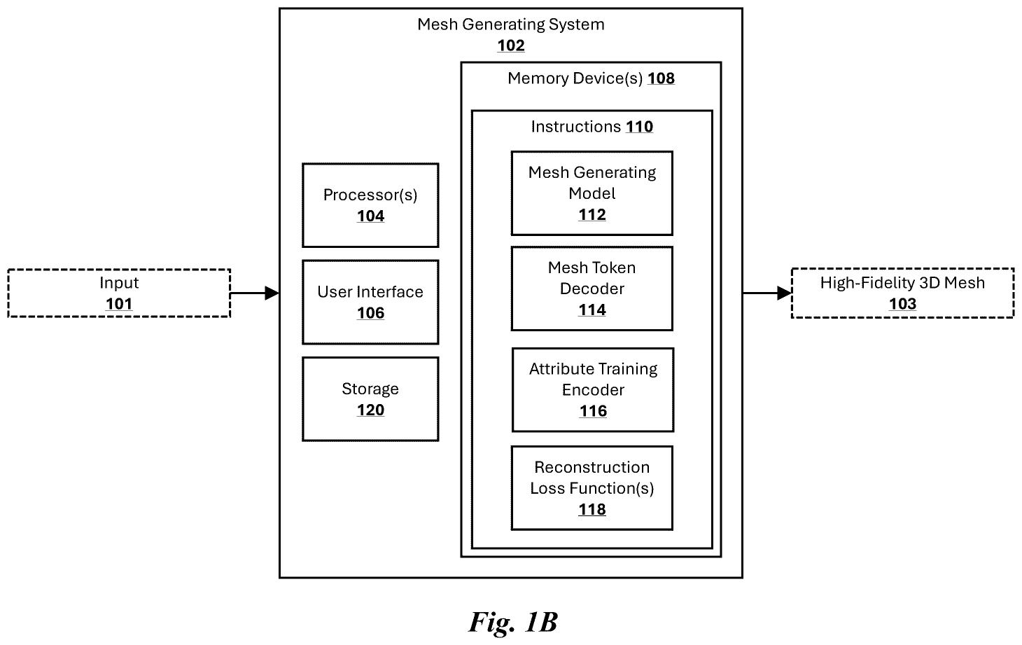

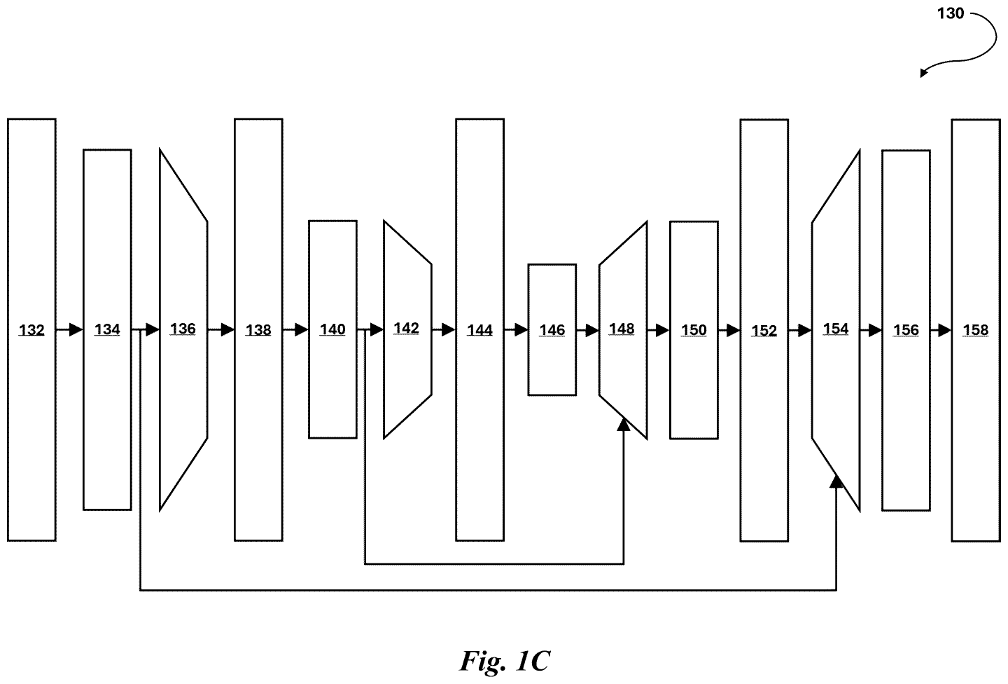

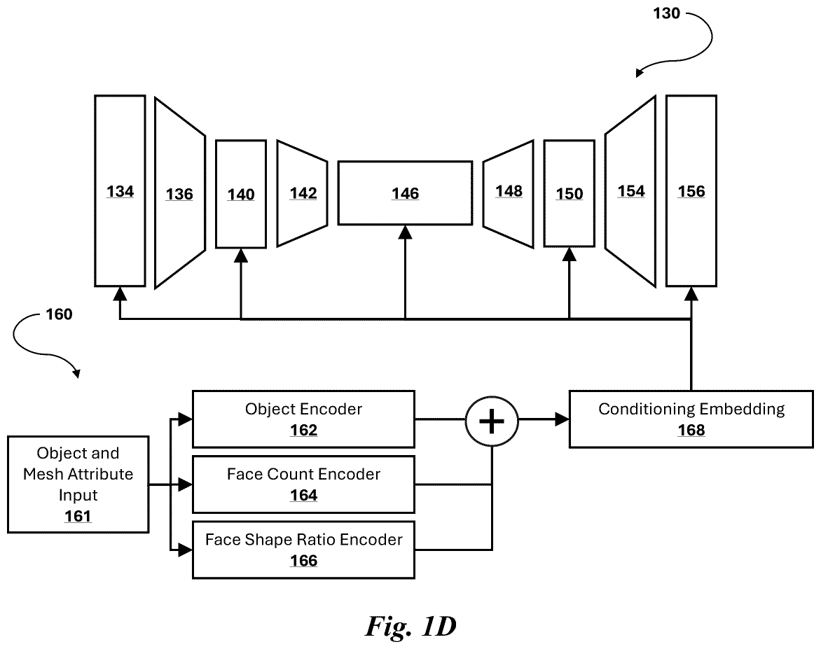

FIG. 1A provides a block diagram of an example framework for generating a 3D mesh that represents an object. The example framework includes a mesh generating system 102. Mesh generating system 102 receives input 101 and generates a high-fidelity 3D mesh 103 as output. In one or more embodiments, input 101 is provided in the form of a 3D representation, e.g., a point cloud, a 3D input mesh, a Neural Radiance Field (NeRF), a Signed Distance Function (SDF), a Sparse Voxel Grid (SVG), and/or a 3D Gaussian representation.

In one or more embodiments, mesh generating system 102 formulates mesh generation as a sequence generation problem. In at least one embodiment, a mesh M of N faces {fⁱ}_{i∈|N|} is defined as a set of its faces: M={f¹, f², . . . fⁿ}, where each face fⁱ is an n-gon defined by n vertices:

$${f}^{i} = {\{ {v}_{j}^{i} \}}_{j ϵ \vert n \vert} .$$

In at least one embodiment, the mesh M is a triangle mesh such that n=3 and a set of three vertices

$${f}^{i} = ( {v}_{1}^{i} , {v}_{2}^{i} , {v}_{3}^{i} )$$

defines each face. In at least one embodiment, the mesh M is defined in [symbol] , and each vertex

$${v}_{j}^{i}$$

is defined by xyz coordinates:

$${v}_{j}^{i} = ( {v}_{j}^{i} x , {v}_{j}^{i} y , {v}_{j}^{i} z ) . ) .$$

In at least one embodiment, the mesh M can be described as a set of faces, vertices or coordinates of length N, nN and 3nN, respectively:

$$M = \{ {f}^{1} , {f}^{2} , … {f}^{n} \} Face level$$

$$= \{ {v}_{1}^{1} , {v}_{2}^{1} , {v}_{3}^{1} , {v}_{1}^{2} , {v}_{2}^{2} , {v}_{3}^{2} , … , {v}_{1}^{N} , {v}_{2}^{N} , {v}_{3}^{N} \} Vertex level$$

$$= \{ {v}_{1}^{1} x , {v}_{1}^{1} y , {v}_{1}^{1} z , {v}_{2}^{1} x , {v}_{2}^{1} y , {v}_{2}^{1} z , … , {v}_{2}^{N} x , {v}_{2}^{N} y , {v}_{2}^{N} z , {v}_{3}^{N} x , {v}_{3}^{N} y , {v}_{3}^{N} z \} Coord . level$$

In one or more embodiments, mesh generating system 102 generates the mesh M in an autoregressive manner by sequentially predicting each coordinate cᵢ based on its conditional probability given all previously generated coordinates c_{<i}:p(cᵢ|c_{<i}). In at least one embodiment, mesh generating system 102 generates a token for each coordinate cᵢ. In at least one embodiment, each token is a discrete token or a continuous token. In at least one embodiment, a probability of an entire mesh M is represented by a joint probability of all coordinates of the mesh:

$$p ( M ) = {\prod }_{i ∈ 3 nN} p ( {c}_{i} \vert {c}_{< i} ) .$$

In at least one embodiment, for an autoregressive model to function properly, a consistent convention to order mesh sequences is required. In at least one embodiment, the mesh M is segmented into a plurality of parts, the parts are arranged in yzx order, where y represents a vertical axis, z represents a depth axis, and x represents a horizontal axis, and vertices within each part are arranged in yzx order. In at least one embodiment, vertices within each face are sorted lexicographically, placing a lowest yzx-ordered vertex first. In at least one embodiment, faces are sorted in ascending yzx-order based on sorted values of their vertices.

FIG. 1B illustrates a block diagram of an example system 100 for generating a 3D mesh that represents an object. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of the system 100 is within the scope and spirit of embodiments of the present disclosure.

Mesh generating system 102 is configured to transform input data into a 3D mesh. Mesh generating system 102 includes one or more processor(s) 104, a user interface 106, and one or more memory devices 108. In at least one embodiment, memory devices 108 store instructions 110 that, when executed by the one or more processor(s) 104, cause mesh generating system 102 to perform various functions including but not limited to a mesh generating model 112, a mesh token encoder decoder 114, an attribute training encoder 116, and attribute training reconstruction loss function(s) 118. In at least one embodiment, mesh generating model 112 is trained to generate a 3D mesh having attributes of at least one other 3D object by using a curated set of training objects where one or more attributes are present. In at least one embodiment, mesh generating model 112 generates 3D mesh of object 124 having at least one of a selected amount of symmetry, number of polygons used, polygon density, and/or polygon shape such as triangle or quadrilateral polygons. In at least one embodiment, mesh generating model 112 is an autoregressive mesh generating model.

In at least one embodiment, mesh generating system 102 receives input 101. In at least one embodiment, input 101 includes a 3D representation of an object in a data format readable by mesh generating system 102. In at least one embodiment, input 101 includes a point cloud, a 3D input mesh, a Neural Radiance Field (NeRF), a Signed Distance Function (SDF), a Sparse Voxel Grid (SVG), and/or a 3D Gaussian representation. In at least one embodiment, input 101 is processed by mesh generating model 112 to generate one or more vertices of high-fidelity 3D mesh 103. In at least one embodiment, mesh token decoder 114 decodes a set of tokens that represent vertices of polygons used to render a 3D mesh. In at least one embodiment, mesh token decoder 114 decodes output from mesh generating model 112 into high-fidelity 3D mesh 103.

In at least one embodiment, attribute training encoder 116 encodes a training set of objects to remove desired attributes and then trains mesh generating model 112 to reconstruct desired attributes using encoded training set as input data and original objects as ground truth. In at least one embodiment, attribute training reconstruction loss function(s) 118 are used to compare training data mesh to generated mesh and update mesh generating model 112 based on a reconstruction loss. In at least one embodiment, storage 120 is used to store input 101 and high-fidelity 3D mesh 103. In at least one embodiment, storage 120 is a machine-readable medium having stored thereon a set of instructions, which if performed by one or more processors, cause one or more processors to at least to cause one or more neural networks to generate one or more vertices of a mesh based, at least in part, on one or more three-dimensional representations of one or more objects. In at least one embodiment, user interface 106 allows users to interact with mesh generating system 102 and provide input data for mesh generation.

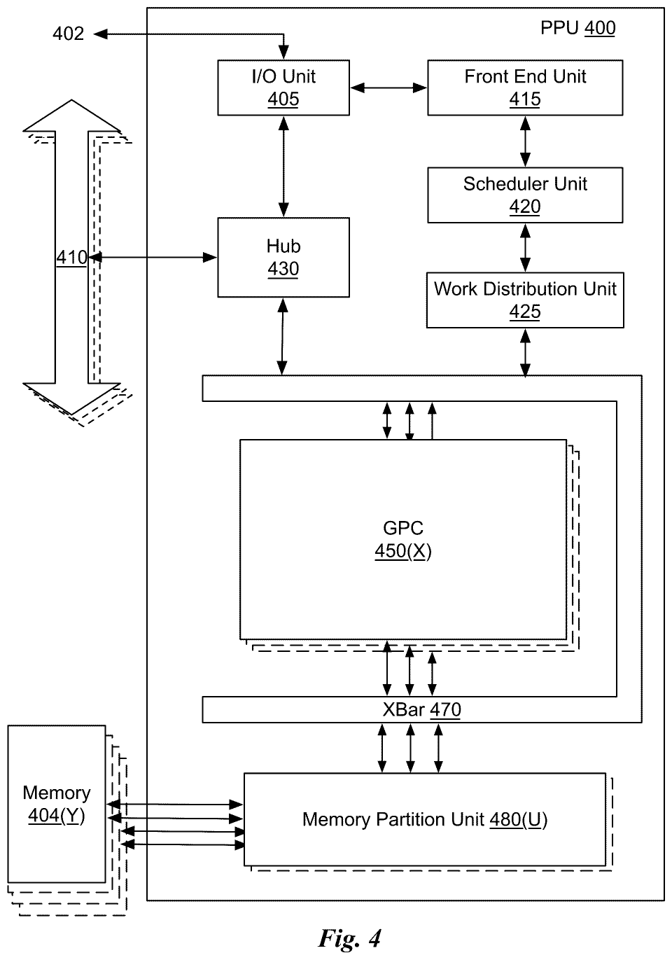

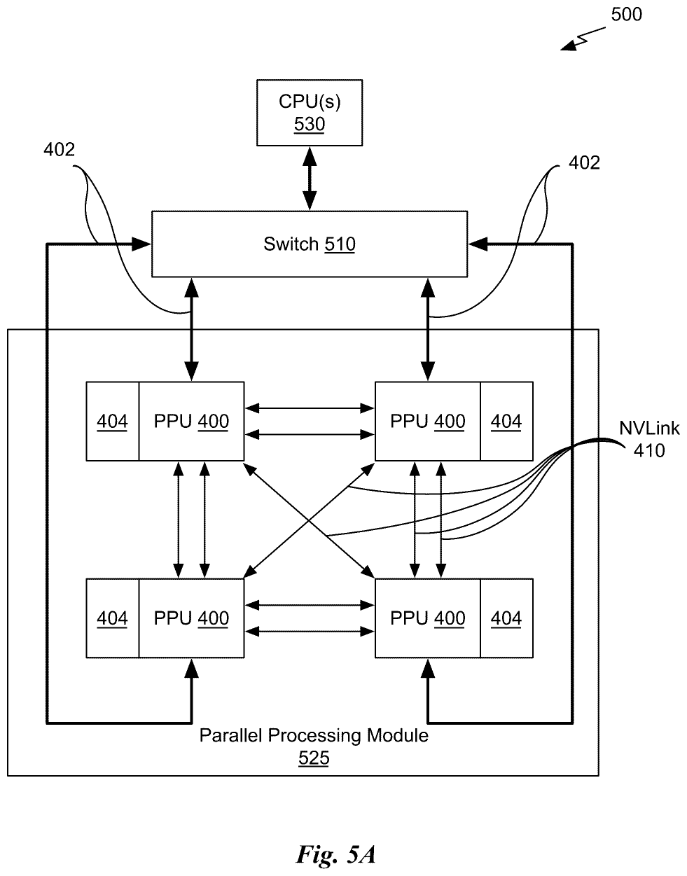

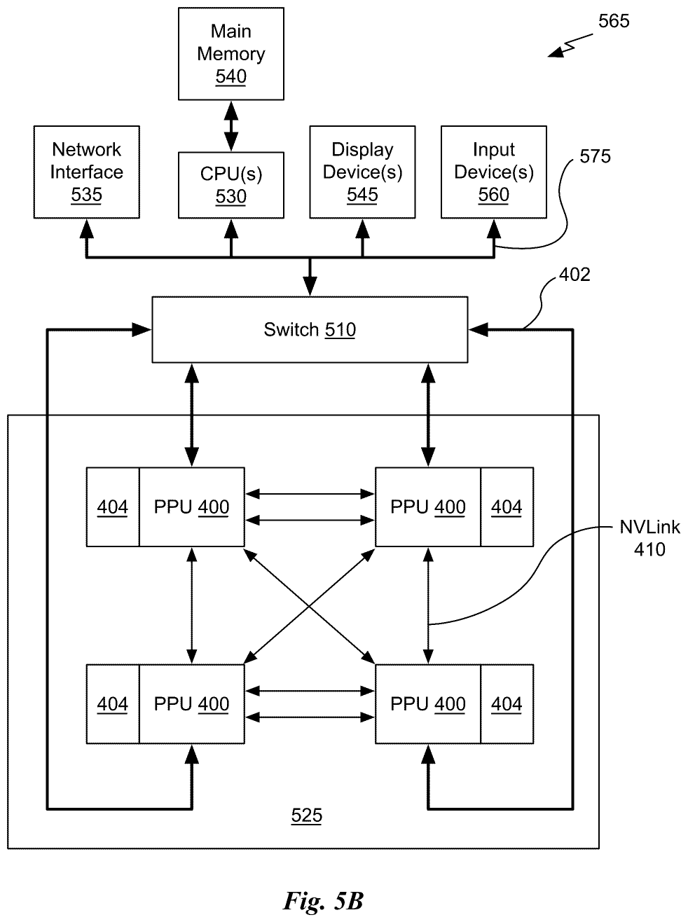

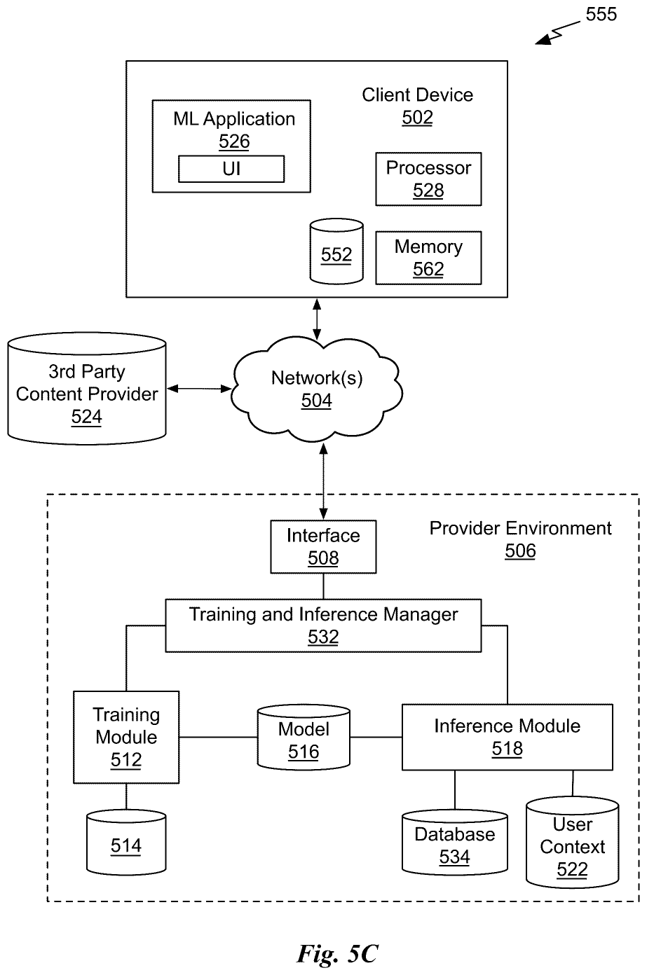

In at least one embodiment, the one or more processor(s) 104 may include one or more parallel processing units (PPU(s)), such as one or more graphics processing units (GPU(s)). In at least one embodiment, the one or more processor(s) 104 include massively parallel GPU(s). In at least one embodiment, massively parallel GPU(s) refer to a collection of one or more GPUs, or any suitable processing units, which may be utilized to perform various processes in parallel. In at least one embodiment, processor(s) 104 may be implemented, for example, using a main central processing unit (CPU) complex, one or more microprocessors, one or more microcontrollers, PPU(s) (e.g., GPU(s)), one or more data processing units (DPU(s)), one or more arithmetic logic units (ALU(s)). In various embodiments, processor(s) 104 may include one or more of the example PPUs illustrated in FIG. 4 or may include one or more instances of the processing system illustrated in FIG. 5. In various embodiments, memory device(s) 108 (e.g., one or more non-transitory processor-readable medium) may be implemented, using volatile memory (e.g., dynamic random-access memory (DRAM)) and/or nonvolatile memory (e.g., a hard drive, a solid-state device (SSD)). In various embodiments, user interface 106 includes one or more input/output devices that allow a user to cause one or more instructions 110 to be performed by the one or more processor(s) 104.

Scaling mesh generation to large, realistic meshes is a challenging task. A 3D mesh with N faces is represented as a sequence of 3nN coordinates, where n is the number of vertices per face. A high-fidelity triangle mesh can have, e.g., 32K faces—which requires a sequence of 288K tokens to provide a token for each vertex coordinate. Due to quadratic computing complexity and linear memory requirements, training an autoregressive neural network (e.g., a transformer backbone) to learn the conditional probability p(cᵢ|c_{<i}) quickly becomes prohibitively expensive. State-of-the-art mesh generation techniques utilizing cutting-edge hardware can only generate sequences of up to ˜8K tokens, i.e., two orders of magnitude less than the required sequence length for high-fidelity 3D meshes. According to one or more embodiments, the mesh generating system 102 includes and employs one or more design features and/or benefits from one or more training techniques that address the challenges of scaling mesh generation to large, realistic meshes.

According to one or more embodiments, a mesh generating system (e.g., mesh generating system 102) and techniques for training a mesh generation model (e.g., mesh generating model 112) leverage inherent patterns and regularities present in the mesh generation process.

According to one or more embodiments, a mesh generating system (e.g., mesh generating system 102) and techniques for training a mesh generation model (e.g., mesh generating model 112) exploit the property that, unlike text sequences used by LLMs, mesh sequences contain less information per token and are only meaningful when processed in groups. In at least one embodiment, a mesh sequence consists of 3n-token groups, each group of 3n tokens representing an n-sided polygon of a polygon mesh. In at least one embodiment, a mesh sequence consists of 9-token groups, each group of 9 tokens representing a triangle of a triangle mesh. In at least one embodiment, the tokens of each token group are organized in a two level hierarchy, every 3 tokens collectively representing a vertex and every group of 3n tokens collectively representing a n-sided polygon. Within a mesh, vertex sharing across adjacent triangles leads to repeated tokens within a mesh sequence. Early tokens within each triangle are easier to generate than later ones, as indicated by average lower perplexity values. Similarly, within each vertex, later tokens tend to be harder to predict. Training an autoregressive mesh generation model to process tokens as groups as cohesive units allows the model to gain a better understanding of a mesh structure.

FIG. 1C illustrates an example neural network architecture for a mesh generating model (e.g., the mesh generating model 112 of FIG. 1B) for generating a 3D mesh. It should be understood that this and other arrangements described herein are set forth only as examples. Other architectures may be used in addition to or instead of those shown, and some architectural components may be omitted altogether. Further, many of the elements described are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

The neural network architecture illustrated in FIG. 1C is an Hourglass Transformer backbone 130. The Hourglass Transformer backbone includes a sequence of transformer stacks (i.e., transformer stacks 134, 140, 146, 150, and 156) separated by downsampling (or shortening) layers (i.e., shortening layers 136 and 142) and upsampling layers (i.e., upsampling layers 148 and 154), each transformer stack including one or more transformer blocks. In at least one embodiment, the one or more transformer blocks are decoder only transformer blocks.

The Hourglass Transformer backbone 130 includes two shortening layers (i.e., shortening layers 136 and 142), each reducing a sequence length of a token sequence (i.e., token sequences 132 and 138) by a factor of 3. In at least one embodiment, this creates a three-stage model, where shortened stages correspond to token groups representing vertices (i.e., token sequence 138) and faces (i.e., token sequence 144) of a mesh. The input token sequence (i.e., token sequence 132) provides tokens that each represent a coordinate (e.g., a y-, z-, or x-coordinate) of a vertex of a face of the mesh. In at least one embodiment, shortening layers merge groups of token embeddings into a single embedding via average, linear or attention pooling. In at least one embodiment, conversely, upsampling layers (i.e., upsampling layers 148 and 154) expand a single embedding back to multiple tokens (i.e., to token sequences 152 and 158) through repeating, linear upsampling or attention upsampling before combining it with a higher-resolution sequences (i.e., produced by transformer stack 134 from token sequence 132 or by transformer stack 140 from token sequence 138) from early layers via residual connections. In at least one embodiment, upsampling layers also shift an upsampled sequence to preserve causality.

In at least one embodiment, the mesh generation model (e.g., the mesh generating model 112 of FIG. 1B, e.g., having the Hourglass Transformer architecture 130 of FIG. 1C) is a point cloud conditioned mesh generation model. In at least one embodiment, point cloud is a flexible and universal 3D representation that can be derived from other 3D representations, mesh included, efficiently. In at least one embodiment, a point cloud is encoded into 1024 embeddings via a jointly-trained Perceiver encoder. In at least one embodiment, additionally, generation is conditioned on a face count and a flag for quad topology. In at least one embodiment, this provides control over a mesh density and a quad-dominancy of a generated meshes during inference. In at least one embodiment, these conditional variables are encoded into their respective embeddings via an MLP. In at least one embodiment, all conditioning variables are concatenated and passed through cross-attention layers in transformer stacks for conditioning.

FIG. 1D illustrates an example architecture for a conditioned mesh generating model (having the Hourglass Transformer architecture 130 of FIG. 1C) for generating a 3D mesh. It should be understood that this and other arrangements described herein are set forth only as examples. Other architectures may be used in addition to or instead of those shown, and some architectural components may be omitted altogether. Further, many of the elements described are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

The conditioned mesh generating model of FIG. 1D includes the Hourglass Transformer architecture 130 of FIG. 1C and a plurality of encoders (i.e., object encoder 162, face count encoder 164, and face shape ratio encoder 166) configured to receive object and mesh attribute input 161, to encode respective conditional variables (e.g., a point cloud, a face count, and a quad face ratio) into respective embeddings, and a concatenation module configured to receive the encoded conditional variables and concatenate them to provide a conditioning embedding 168 that is provided to cross attention layers of transformer stacks 134, 140, 146, 150, and 156 of the Hourglass Transformer architecture 130.

Due to the extreme length of mesh sequences (which can be in the hundreds of thousands of tokens), training on full mesh sequences can be prohibitively expensive, even with memory and computation savings of an Hourglass Transformer architecture. Furthermore, a wide variation in sequence lengths can hinder the implementation of efficient training setups, even with advanced parallelization techniques in place. Fortunately, inherent patterns and regularities present in the mesh generation process can be exploited to scale generation to very long mesh sequences.

According to one or more embodiments, a mesh generating system (e.g., mesh generating system 102) and techniques for training a mesh generation model (e.g., mesh generating model 112) employ an ordering of the mesh sequence in which polygons (e.g., triangles) are sorted from bottom to top, layer by layer, promoting a locality of adjacent polygons within the sequence. In at least one embodiment, during inference, ordering is enforced to prevent inconsistent sequences and ensure robust mesh generation. In at least one embodiment, specifically, a generation process is constrained so that a coordinates of vertices within each face follow a lexicographic ascending order, and coordinates of subsequent faces are also organized in lexicographic ascending order relative to a last generated face.

Assuming proper global conditioning, generation of a subsequent triangle can therefore be based only on information from adjacent tokens, specifically vertex positions of nearby triangles. In at least one embodiment, a mesh generating system (e.g., mesh generating system 102) and techniques for training a mesh generation model (e.g., mesh generating model 112) exploit this ordering of the mesh sequence to allow a sliding window approach for efficient training and inference. In at least one embodiment, a mesh generation model is trained with fixed-length truncated segments of mesh sequences to significantly reduce compute and memory consumption during training. In at least one embodiment, the mesh generation model uses, during inference, sliding-window attention or rolling KV-cache with a buffer size equal to an attention window to achieve linear complexity.

However, training on truncated mesh sequences would either (i) make a conditional signal visible to only a few mesh segments, or (ii) require complex concatenation strategies during training and inference. In at least one embodiment, to address this, cross-attention is used to condition globally on all mesh segments regardless of their position within the mesh sequence. In at least one embodiment, this allows a model to efficiently leverage both local and global information during training and inference, leading to accurate predictions while maintaining low resource requirements. In at least one embodiment, following a multimodal approach, every 4th layer in a transformer stack (e.g., transformer stacks 134, 140, 146, 150, and 156 of Hourglass Transformer architecture 130) is replaced with a cross-attention layer to enable interaction between a main model and conditioning embeddings.

In at least one embodiment, in addition to vertex coordinates, four additional tokens may be used: start-of-sequence(S), end-of-sequence (E), start-of-part (SP), and end-of-part (EP). In at least one embodiment, a mesh generating model prepends 9 (S) tokens at a beginning of each mesh sequence, appends 9 (E) tokens at an end of the mesh sequence, appends 9 (SP) tokens at a beginning of each part of the mesh, and appends 9 (EP) tokens at an end of each part. In at least one embodiment, padding tokens are used to fill batched sequences of different lengths. In at least one embodiment, tokens in groups of 9 are used to ensure that a structure of a mesh sequence is preserved at face and vertex levels in order to preserve structure in an Hourglass model.

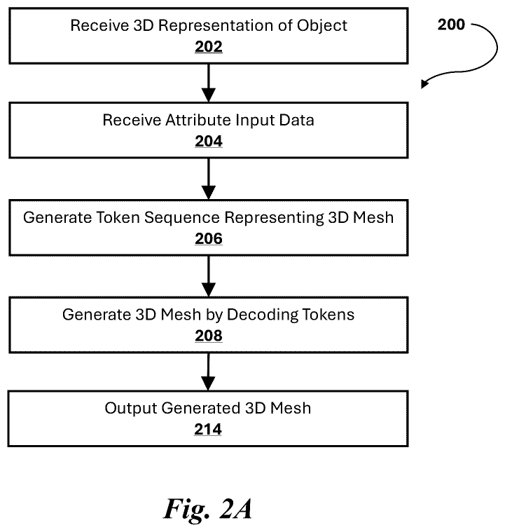

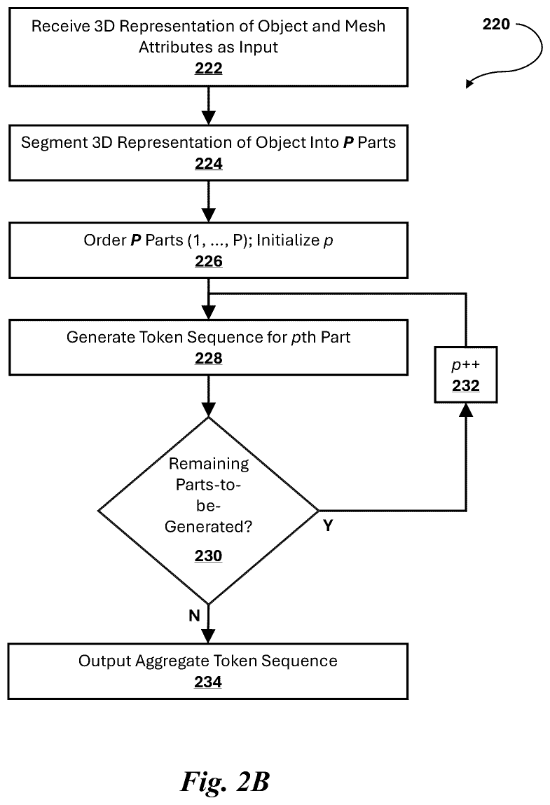

FIG. 2A illustrates a flowchart of an example method 200 for generating a mesh. Each block of method 200, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 200 is described, by way of example, with respect to the framework of FIG. 1A and the system of FIG. 1B. However, this method may additionally or alternatively be executed by any one system, or any combination of systems, including, but not limited to, those described herein. Furthermore, persons of ordinary skill in the art will understand that any system that performs method 200 is within the scope and spirit of embodiments of the present disclosure.

Method 200 begins with receiving a 3D representation of an object at step 202. In at least one embodiment, a 3D representation of object is in a data format readable by mesh generating system 102. At 204, method 200 receives attribute input data. In at least one embodiment, attribute input data includes one or more attributes to be applied to the 3D mesh to be generated. In at least one embodiment, attribute input data includes at least one of polygon symmetry, count, density, and/or shape. At 206, method 200 generates a sequence of tokens representing a polygon of the mesh using a mesh generating model, e.g., mesh generating model 112. In at least one embodiment, the tokens represent coordinates of vertices of polygons used to render the 3D mesh. In at least one embodiment, the tokens represent vertices of polygons used to render the 3D mesh. In at least one embodiment, the tokens represent polygons used to render the 3D mesh. At 208, method 200 generates the 3D mesh representing the object by decoding the tokens. In at least one embodiment, mesh token encoder/decoder 114 decodes output from mesh generating model 112 into a 3D mesh of an object. Method 200 concludes by outputting the generated 3D mesh at 210. In at least one embodiment, the generated 3D mesh is stored in a storage device or provided to a user through a user interface.

FIG. 2B illustrates a flowchart of an example method 220 for generating a token sequence for a 3D mesh via a part-by-part process. Each block of method 220, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 220 is described, by way of example, with respect to the framework of FIG. 1A and the system of FIG. 1B. However, this method may additionally or alternatively be executed by any one system, or any combination of systems, including, but not limited to, those described herein. Furthermore, persons of ordinary skill in the art will understand that any system that performs method 220 is within the scope and spirit of embodiments of the present disclosure.

At 222, method 220 receives a 3D representation of an object and attribute input data. In at least one embodiment, the 3D representation of the object is in a data format readable by mesh generating system 102. In at least one embodiment, the attribute input data includes one or more attributes to be applied to the 3D mesh to be generated, e.g., polygon symmetry, count, density, and/or shape. At 224, method 220 segments the input 3D representation into a plurality of P parts. At 226, method 220 orders the P parts, e.g., by arranging them in yzx order, and initializes p. In at least one embodiment, method 220 additionally generates start-of-sequence tokens (e.g., 9 S tokens) at 226. At 228, method 220 generates token sequence for the pth part. In at least one embodiment, generating the 3D mesh for the pth part includes (i) first generating start-of-part tokens (e.g., 9 SP tokens), (ii) subsequently generating coordinate, vertex, and/or face level tokens for the faces, vertices, and/or vertex coordinates of the pth part, and (iii) finally generating end-of-part tokens (e.g., 9 EP tokens). Following the generation of the token sequence for the pth part, method 200 determines, at 230, whether any parts remain, and if so, method 220 increments p at 232 and returns to 228 to generate a token sequence for a next part. Alternatively, if all parts have been generated, method 220 outputs an aggregate token sequence that includes the token sequences for each of the p parts at 234. In at least one embodiment, method 220 additionally generates end-of-sequence (e.g., 9 E tokens) at 234.

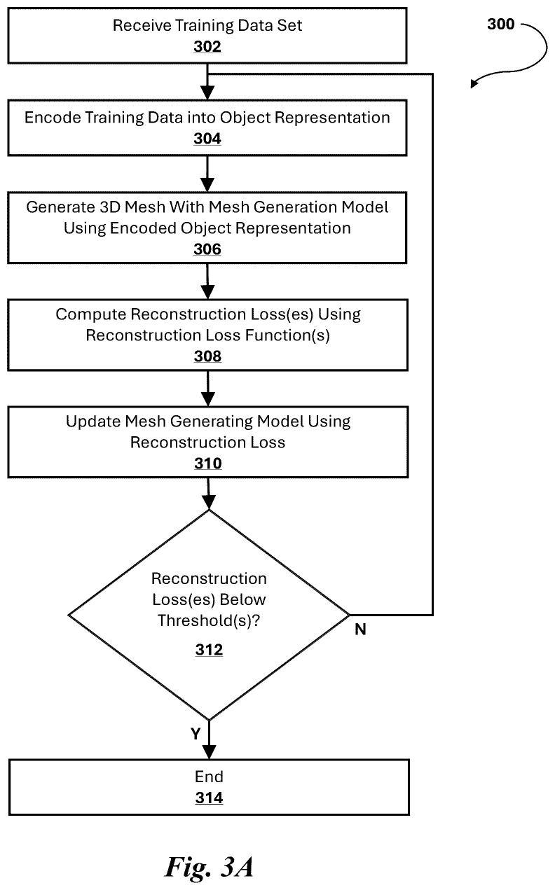

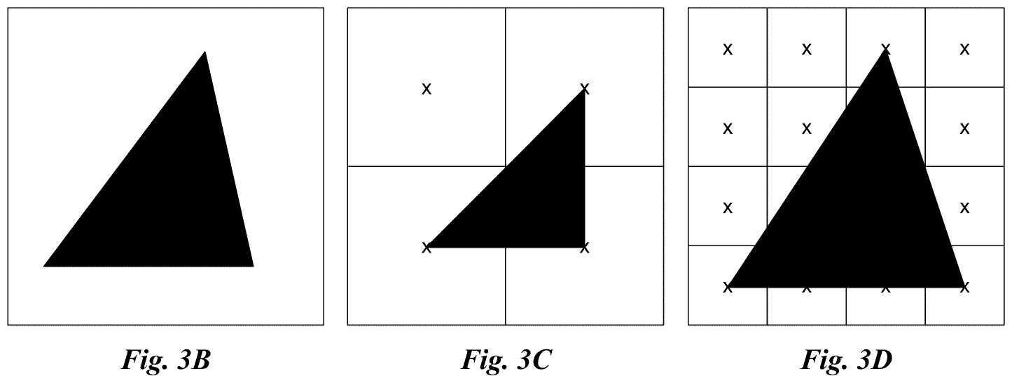

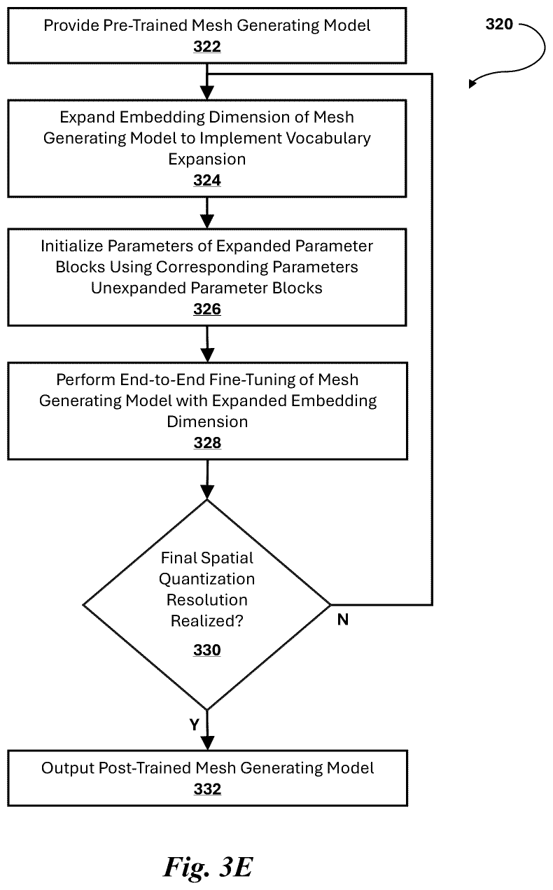

FIG. 3A illustrates a flowchart of an example method 300 for training a mesh generating model (e.g., the mesh generating model 112 of FIG. 1B having, e.g., the Hourglass Transformer architecture of FIG. 1C) to generate a 3D mesh. Each block of method 300, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 300 is described, by way of example, with respect to the framework of FIG. 1A and the system of FIG. 1B. However, this method may additionally or alternatively be executed by any one system, or any combination of systems, including, but not limited to, those described herein. Furthermore, persons of ordinary skill in the art will understand that any system that performs method 300 is within the scope and spirit of embodiments of the present disclosure.

At 302, method 300 receives a training data set. In at least one embodiment, the training data set comprises a set of curated meshes having desired attributes to be present in an output 3D mesh. At 304, method 300 encodes training data from the training data set into a set of object representations. In at least one embodiment, encoding training data at 304 involves removing desired attributes from curated meshes of the training data set to create encoded object representations. At 306, method 300 generates, by the mesh generating model, a respective 3D mesh as output using a respective encoded object representation as input. At 308, method 300 computes one or more reconstruction losses using one or more reconstruction loss function(s) to compare the respective 3D mesh generated as output to a ground truth 3D mesh that corresponds to the respective encoded object representation. At 310, method 300 updates the mesh generating model based on the one or more reconstruction losses to provide an updated mesh generating model. At 312, method 300 determines whether the one or more reconstruction losses are below one or more pre-defined thresholds. If the one or more reconstruction losses are below the one or more pre-defined threshold, method 300 ends. Alternatively, if the one or more reconstruction losses are not below the one or more thresholds, the method returns to 306 and performs an additional training iteration.

In at least one embodiment, a mesh generating system (e.g., mesh generating system 102) and techniques for training a mesh generation model (e.g., mesh generating model 112) utilize discrete tokens to represent coordinates of vertices of faces of a 3D mesh. Discrete token can provide for different levels of quantization. In at least one embodiment, an autoregressive mesh generation model (e.g., having the Hourglass Transformer architecture 130), models sampling from a multinomial distribution over a discrete set of possible values. In at least one embodiment, coordinates cᵢ are quantized into a fixed number of discrete bins. A resolution of a quantization grid, which is determined by the fixed number of the discrete bins, directly affects a precision of the generated 3D mesh. Higher quantization levels provide more detailed and accurate representations but increase complexity of both the mesh generation process and the process of training a neural network (e.g., having the Hourglass Transformer architecture 130) to generate a 3D mesh. Alternatively, lower quantization levels are unable to provide a high level of detail and the resulting 3D meshes lack accuracy, but the computational complexity of both mesh generation and training is greatly reduced.

FIGS. 3B, 3C, and 3D illustrate representing a triangle of a 3D triangle mesh with different levels of quantization. In FIG. 3B, no quantization of the vertices of the triangle is provided, which FIGS. 3C and 3D provide different levels of quantization of the x- and y-spatial dimensions to represent the triangle of FIG. 3B. FIG. 3C provides only a 2-level quantization of both the x- and y-spatial dimensions, while FIG. 3D provides a 4-level quantization of both the x- and y-spatial dimensions to provide a more accurate representation of the triangle of FIG. 3B.

FIG. 3E illustrates a flowchart of an example method 320 for training a mesh generating model (e.g., the mesh generating model 112 of FIG. 1B having, e.g., the Hourglass Transformer architecture 130 of FIG. 1C) to generate a 3D mesh. Each block of method 320, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 320 is described, by way of example, with respect to the framework of FIG. 1A and the system of FIG. 1B. However, this method may additionally or alternatively be executed by any one system, or any combination of systems, including, but not limited to, those described herein. Furthermore, persons of ordinary skill in the art will understand that any system that performs method 320 is within the scope and spirit of embodiments of the present disclosure.

At 322, method 320 provides a mesh generating model (e.g., a mesh generating model having an Hourglass Transformer backbone) that has been pretrained to generate, based on input (e.g., input including a 3D representation such as a point cloud), a 3D mesh. In at least one embodiment, the pretrained mesh generating model is pretrained using method 300 of FIG. 3A. The pretrained mesh generating model is configured to generate a sequence of discrete tokens that each represents a coordinate of a vertex of a polygon of a polygon mesh, each discrete token being represented with a first level of spatial resolution (e.g., a 128-level quantization). At 324, method 320 implements a vocabulary expansion to increase the embedding dimension of the tokens processed by the mesh generating model (e.g., by expanding an embedding dimension of individual transformer blocks of an Hourglass Transformer backbone), thereby increasing the level of spatial resolution of tokens processed by and generated by the mesh generating model to a second level of spatial resolution (e.g., a 256-level quantization). Implementing the vocabulary expansion entails expanding a weight matrix of a final linear layer that projects output embeddings in the hidden space (i.e., of the transformer blocks of the Hourglass Transformer backbone) into the logits space. In at least one embodiment, each iteration of vocabulary expansion increases the length of each row of the weight matrix of the final linear layer by a factor of 2. At 326, method 320 initializes parameters of the expanded weight matrix of the final linear layer. In at least one embodiment, the parameters of the expanded weight matrix are initialized by duplicating the parameters of the unexpanded weight matrix of the pretrained mesh generating model.

At 328, method 320 performs an end-to-end fine tuning process, thereby providing an updated mesh generating model configured to generate a sequence of discrete tokens that each represents a coordinate of a vertex of a polygon of a polygon mesh, each discrete token being represented with a second level of spatial resolution. In at least one embodiment, the end-to-end fine tuning process is performed by using method 300 of FIG. 3A. At 330, method 320 determines whether the final spatial quantization resolution (e.g., 1024-level quantization) has been realized. If not, method 320 returns to 324 and implements an additional iteration of vocabulary expansion and fine-tuning. Alternatively, if the final spatial quantization resolution has been realized, method 320 proceeds to 332 and outputs a final, post-trained mesh generating model.

By performing iterative vocabulary expansions and fine-tuning processes, method 320 produces a post-trained mesh generating model (e.g., having a final Hourglass Transformer backbone configured to generate tokens representing mesh vertex coordinates, vertices, and/or faces with a desired spatial quantization resolution) far more efficiently than via direct, end-to-end training at the finest quantization level. For example, via the progressive training technique of FIG. 3E, an initial Hourglass Transformer backbone with 128-coordinate level quantization of mesh vertices can yield a final Hourglass Transformer backbone with 1024-coordinate level quantization of mesh vertices via only 3 iterations of vocabulary expansion and continued training. Training the initial Hourglass Transformer backbone with 128-level quantization of mesh vertices and performing 3 iterations of vocabulary expansion is far more compute efficient than directly training a final Hourglass Transformer backbone with 1024-level quantization. For example, progressive training is able to achieve convergence much more quickly, achieving lower perplexity for a given amount of compute. As a result, progressive training yields higher performance Hourglass Transformer backbones with less compute, resulting in significant cost and energy savings.

### Parallel Processing Architecture

FIG. 4 illustrates a parallel processing unit (PPU) 400, in accordance with an embodiment. The PPU 400 may be used to implement one or more components of systems 250B and 250E of FIGS. 2B and 2E. The PPU 400 may be used to performs one or more steps of methods 200, 210, and 230.

In an embodiment, the PPU 400 is a multi-threaded processor that is implemented on one or more integrated circuit devices. The PPU 400 is a latency hiding architecture designed to process many threads in parallel. A thread (e.g., a thread of execution) is an instantiation of a set of instructions configured to be executed by the PPU 400. In an embodiment, the PPU 400 is a graphics processing unit (GPU) configured to implement a graphics rendering pipeline for processing three-dimensional (3D) graphics data in order to generate two-dimensional (2D) image data for display on a display device. In other embodiments, the PPU 400 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more PPUs 400 may be configured to accelerate thousands of High Performance Computing (HPC), data center, cloud computing, and machine learning applications. The PPU 400 may be configured to accelerate numerous deep learning systems and applications for autonomous vehicles, simulation, computational graphics such as ray or path tracing, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 4, the PPU 400 includes an Input/Output (I/O) unit 405, a front end unit 415, a scheduler unit 420, a work distribution unit 425, a hub 430, a crossbar (Xbar) 470, one or more general processing clusters (GPCs) 450, and one or more memory partition units 480. The PPU 400 may be connected to a host processor or other PPUs 400 via one or more high-speed NVLink 410 interconnect. The PPU 400 may be connected to a host processor or other peripheral devices via an interconnect 402. The PPU 400 may also be connected to a local memory 404 comprising a number of memory devices. In an embodiment, the local memory may comprise a number of dynamic random access memory (DRAM) devices. The DRAM devices may be configured as a high-bandwidth memory (HBM) subsystem, with multiple DRAM dies stacked within each device.

The NVLink 410 interconnect enables systems to scale and include one or more PPUs 400 combined with one or more CPUs, supports cache coherence between the PPUs 400 and CPUs, and CPU mastering. Data and/or commands may be transmitted by the NVLink 410 through the hub 430 to/from other units of the PPU 400 such as one or more copy engines, a video encoder, a video decoder, a power management unit, etc. (not explicitly shown). The NVLink 410 is described in more detail in conjunction with FIG. 5B.

The I/O unit 405 is configured to transmit and receive communications (e.g., commands, data, etc.) from a host processor (not shown) over the interconnect 402. The I/O unit 405 may communicate with the host processor directly via the interconnect 402 or through one or more intermediate devices such as a memory bridge. In an embodiment, the I/O unit 405 may communicate with one or more other processors, such as one or more the PPUs 400 via the interconnect 402. In an embodiment, the I/O unit 405 implements a Peripheral Component Interconnect Express (PCIe) interface for communications over a PCIe bus and the interconnect 402 is a PCIe bus. In alternative embodiments, the I/O unit 405 may implement other types of well-known interfaces for communicating with external devices.

The I/O unit 405 decodes packets received via the interconnect 402. In an embodiment, the packets represent commands configured to cause the PPU 400 to perform various operations. The I/O unit 405 transmits the decoded commands to various other units of the PPU 400 as the commands may specify. For example, some commands may be transmitted to the front end unit 415. Other commands may be transmitted to the hub 430 or other units of the PPU 400 such as one or more copy engines, a video encoder, a video decoder, a power management unit, etc. (not explicitly shown). In other words, the I/O unit 405 is configured to route communications between and among the various logical units of the PPU 400.

In an embodiment, a program executed by the host processor encodes a command stream in a buffer that provides workloads to the PPU 400 for processing. A workload may comprise several instructions and data to be processed by those instructions. The buffer is a region in a memory that is accessible (e.g., read/write) by both the host processor and the PPU 400. For example, the I/O unit 405 may be configured to access the buffer in a system memory connected to the interconnect 402 via memory requests transmitted over the interconnect 402. In an embodiment, the host processor writes the command stream to the buffer and then transmits a pointer to the start of the command stream to the PPU 400. The front end unit 415 receives pointers to one or more command streams. The front end unit 415 manages the one or more streams, reading commands from the streams and forwarding commands to the various units of the PPU 400.

The front end unit 415 is coupled to a scheduler unit 420 that configures the various GPCs 450 to process tasks defined by the one or more streams. The scheduler unit 420 is configured to track state information related to the various tasks managed by the scheduler unit 420. The state may indicate which GPC 450 a task is assigned to, whether the task is active or inactive, a priority level associated with the task, and so forth. The scheduler unit 420 manages the execution of a plurality of tasks on the one or more GPCs 450.

The scheduler unit 420 is coupled to a work distribution unit 425 that is configured to dispatch tasks for execution on the GPCs 450. The work distribution unit 425 may track a number of scheduled tasks received from the scheduler unit 420. In an embodiment, the work distribution unit 425 manages a pending task pool and an active task pool for each of the GPCs 450. As a GPC 450 finishes the execution of a task, that task is evicted from the active task pool for the GPC 450 and one of the other tasks from the pending task pool is selected and scheduled for execution on the GPC 450. If an active task has been idle on the GPC 450, such as while waiting for a data dependency to be resolved, then the active task may be evicted from the GPC 450 and returned to the pending task pool while another task in the pending task pool is selected and scheduled for execution on the GPC 450.

In an embodiment, a host processor executes a driver kernel that implements an application programming interface (API) that enables one or more applications executing on the host processor to schedule operations for execution on the PPU 400. In an embodiment, multiple compute applications are simultaneously executed by the PPU 400 and the PPU 400 provides isolation, quality of service (QoS), and independent address spaces for the multiple compute applications. An application may generate instructions (e.g., API calls) that cause the driver kernel to generate one or more tasks for execution by the PPU 400. The driver kernel outputs tasks to one or more streams being processed by the PPU 400. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. The tasks may be allocated to one or more processing units within a GPC 450 and instructions are scheduled for execution by at least one warp.

The work distribution unit 425 communicates with the one or more GPCs 450 via XBar 470. The XBar 470 is an interconnect network that couples many of the units of the PPU 400 to other units of the PPU 400. For example, the XBar 470 may be configured to couple the work distribution unit 425 to a particular GPC 450. Although not shown explicitly, one or more other units of the PPU 400 may also be connected to the XBar 470 via the hub 430.

The tasks are managed by the scheduler unit 420 and dispatched to a GPC 450 by the work distribution unit 425. The GPC 450 is configured to process the task and generate results. The results may be consumed by other tasks within the GPC 450, routed to a different GPC 450 via the XBar 470, or stored in the memory 404. The results can be written to the memory 404 via the memory partition units 480, which implement a memory interface for reading and writing data to/from the memory 404. The results can be transmitted to another PPU 400 or CPU via the NVLink 410. In an embodiment, the PPU 400 includes a number U of memory partition units 480 that is equal to the number of separate and distinct memory devices of the memory 404 coupled to the PPU 400. Each GPC 450 may include a memory management unit to provide translation of virtual addresses into physical addresses, memory protection, and arbitration of memory requests. In an embodiment, the memory management unit provides one or more translation lookaside buffers (TLBs) for performing translation of virtual addresses into physical addresses in the memory 404.

In an embodiment, the memory partition unit 480 includes a Raster Operations (ROP) unit, a level two (L2) cache, and a memory interface that is coupled to the memory 404. The memory interface may implement 32, 64, 128, 1024-bit data buses, or the like, for high-speed data transfer. The PPU 400 may be connected to up to Y memory devices, such as high bandwidth memory stacks or graphics double-data-rate, version 5, synchronous dynamic random access memory, or other types of persistent storage. In an embodiment, the memory interface implements an HBM2 memory interface and Y equals half U. In an embodiment, the HBM2 memory stacks are located on the same physical package as the PPU 400, providing substantial power and area savings compared with conventional GDDR5 SDRAM systems. In an embodiment, each HBM2 stack includes four memory dies and Y equals 4, with each HBM2 stack including two 128-bit channels per die for a total of 8 channels and a data bus width of 1024 bits.

In an embodiment, the memory 404 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where PPUs 400 process very large datasets and/or run applications for extended periods.

In an embodiment, the PPU 400 implements a multi-level memory hierarchy. In an embodiment, the memory partition unit 480 supports a unified memory to provide a single unified virtual address space for CPU and PPU 400 memory, enabling data sharing between virtual memory systems. In an embodiment the frequency of accesses by a PPU 400 to memory located on other processors is traced to ensure that memory pages are moved to the physical memory of the PPU 400 that is accessing the pages more frequently. In an embodiment, the NVLink 410 supports address translation services allowing the PPU 400 to directly access a CPU's page tables and providing full access to CPU memory by the PPU 400.

In an embodiment, copy engines transfer data between multiple PPUs 400 or between PPUs 400 and CPUs. The copy engines can generate page faults for addresses that are not mapped into the page tables. The memory partition unit 480 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 404 or other system memory may be fetched by the memory partition unit 480 and stored in the L2 cache 460, which is located on-chip and is shared between the various GPCs 450. As shown, each memory partition unit 480 includes a portion of the L2 cache associated with a corresponding memory 404. Lower level caches may then be implemented in various units within the GPCs 450. For example, each of the processing units within a GPC 450 may implement a level one (L1) cache. The L1 cache is private memory that is dedicated to a particular processing unit. The L2 cache 460 is coupled to the memory interface 470 and the XBar 470 and data from the L2 cache may be fetched and stored in each of the L1 caches for processing.

In an embodiment, the processing units within each GPC 450 implement a SIMD (Single-Instruction, Multiple-Data) architecture where each thread in a group of threads (e.g., a warp) is configured to process a different set of data based on the same set of instructions. All threads in the group of threads execute the same instructions. In another embodiment, the processing unit implements a SIMT (Single-Instruction, Multiple Thread) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

Each processing unit includes a large number (e.g., 128, etc.) of distinct processing cores (e.g., functional units) that may be fully-pipelined, single-precision, double-precision, and/or mixed precision and include a floating point arithmetic logic unit and an integer arithmetic logic unit. In an embodiment, the floating point arithmetic logic units implement the IEEE 754-2008 standard for floating point arithmetic. In an embodiment, the cores include 64 single-precision (32-bit) floating point cores, 64 integer cores, 32 double-precision (64-bit) floating point cores, and 8 tensor cores.

Tensor cores configured to perform matrix operations. In particular, the tensor cores are configured to perform deep learning matrix arithmetic, such as GEMM (matrix-matrix multiplication) for convolution operations during neural network training and inferencing. In an embodiment, each tensor core operates on a 4×4 matrix and performs a matrix multiply and accumulate operation D=A×B+C, where A, B, C, and D are 4×4 matrices.

In an embodiment, the matrix multiply inputs A and B may be integer, fixed-point, or floating point matrices, while the accumulation matrices C and D may be integer, fixed-point, or floating point matrices of equal or higher bitwidths. In an embodiment, tensor cores operate on one, four, or eight bit integer input data with 32-bit integer accumulation. The 8-bit integer matrix multiply requires 1024 operations and results in a full precision product that is then accumulated using 32-bit integer addition with the other intermediate products for a 8×8×16 matrix multiply. In an embodiment, tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each processing unit may also comprise M special function units (SFUs) that perform special functions (e.g., attribute evaluation, reciprocal square root, and the like). In an embodiment, the SFUs may include a tree traversal unit configured to traverse a hierarchical tree data structure. In an embodiment, the SFUs may include texture unit configured to perform texture map filtering operations. In an embodiment, the texture units are configured to load texture maps (e.g., a 2D array of texels) from the memory 404 and sample the texture maps to produce sampled texture values for use in shader programs executed by the processing unit. In an embodiment, the texture maps are stored in shared memory that may comprise or include an L1 cache. The texture units implement texture operations such as filtering operations using mip-maps (e.g., texture maps of varying levels of detail). In an embodiment, each processing unit includes two texture units.

Each processing unit also comprises N load store units (LSUs) that implement load and store operations between the shared memory and the register file. Each processing unit includes an interconnect network that connects each of the cores to the register file and the LSU to the register file, shared memory. In an embodiment, the interconnect network is a crossbar that can be configured to connect any of the cores to any of the registers in the register file and connect the LSUs to the register file and memory locations in shared memory.

The shared memory is an array of on-chip memory that allows for data storage and communication between the processing units and between threads within a processing unit. In an embodiment, the shared memory comprises 128 KB of storage capacity and is in the path from each of the processing units to the memory partition unit 480. The shared memory can be used to cache reads and writes. One or more of the shared memory, L1 cache, L2 cache, and memory 404 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory enables the shared memory to function as a high-throughput conduit for streaming data while simultaneously providing high-bandwidth and low-latency access to frequently reused data.

When configured for general purpose parallel computation, a simpler configuration can be used compared with graphics processing. Specifically, fixed function graphics processing units, are bypassed, creating a much simpler programming model. In the general purpose parallel computation configuration, the work distribution unit 425 assigns and distributes blocks of threads directly to the processing units within the GPCs 450. Threads execute the same program, using a unique thread ID in the calculation to ensure each thread generates unique results, using the processing unit(s) to execute the program and perform calculations, shared memory to communicate between threads, and the LSU to read and write global memory through the shared memory and the memory partition unit 480. When configured for general purpose parallel computation, the processing units can also write commands that the scheduler unit 420 can use to launch new work on the processing units.

The PPUs 400 may each include, and/or be configured to perform functions of, one or more processing cores and/or components thereof, such as Tensor Cores (TCs), Tensor Processing Units (TPUs), Pixel Visual Cores (PVCs), Ray Tracing (RT) Cores, Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The PPU 400 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the PPU 400 is embodied on a single semiconductor substrate. In another embodiment, the PPU 400 is included in a system-on-a-chip (SoC) along with one or more other devices such as additional PPUs 400, the memory 404, a reduced instruction set computer (RISC) CPU, a memory management unit (MMU), a digital-to-analog converter (DAC), and the like.

In an embodiment, the PPU 400 may be included on a graphics card that includes one or more memory devices. The graphics card may be configured to interface with a PCIe slot on a motherboard of a desktop computer. In yet another embodiment, the PPU 400 may be an integrated graphics processing unit (iGPU) or parallel processor included in the chipset of the motherboard. In yet another embodiment, the PPU 400 may be realized in reconfigurable hardware. In yet another embodiment, parts of the PPU 400 may be realized in reconfigurable hardware.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 5A is a conceptual diagram of a processing system 500 implemented using the PPU 400 of FIG. 4, in accordance with an embodiment. The exemplary system 565 may be configured, e.g., to implement method 200 shown in FIG. 2A, method 210 shown in FIG. 2C, and/or method 230 shown in FIG. 2D. The processing system 500 includes a CPU 530, switch 510, and multiple PPUs 400, and respective memories 404.

The NVLink 410 provides high-speed communication links between each of the PPUs 400. Although a particular number of NVLink 410 and interconnect 402 connections are illustrated in FIG. 5B, the number of connections to each PPU 400 and the CPU 530 may vary. The switch 510 interfaces between the interconnect 402 and the CPU 530. The PPUs 400, memories 404, and NVLinks 410 may be situated on a single semiconductor platform to form a parallel processing module 525. In an embodiment, the switch 510 supports two or more protocols to interface between various different connections and/or links.

In another embodiment (not shown), the NVLink 410 provides one or more high-speed communication links between each of the PPUs 400 and the CPU 530 and the switch 510 interfaces between the interconnect 402 and each of the PPUs 400. The PPUs 400, memories 404, and interconnect 402 may be situated on a single semiconductor platform to form a parallel processing module 525. In yet another embodiment (not shown), the interconnect 402 provides one or more communication links between each of the PPUs 400 and the CPU 530 and the switch 510 interfaces between each of the PPUs 400 using the NVLink 410 to provide one or more high-speed communication links between the PPUs 400. In another embodiment (not shown), the NVLink 410 provides one or more high-speed communication links between the PPUs 400 and the CPU 530 through the switch 510. In yet another embodiment (not shown), the interconnect 402 provides one or more communication links between each of the PPUs 400 directly. One or more of the NVLink 410 high-speed communication links may be implemented as a physical NVLink interconnect or either an on-chip or on-die interconnect using the same protocol as the NVLink 410.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 525 may be implemented as a circuit board substrate and each of the PPUs 400 and/or memories 404 may be packaged devices. In an embodiment, the CPU 530, switch 510, and the parallel processing module 525 are situated on a single semiconductor platform.

In an embodiment, the signaling rate of each NVLink 410 is 20 to 25 Gigabits/second and each PPU 400 includes six NVLink 410 interfaces (as shown in FIG. 5A, five NVLink 410 interfaces are included for each PPU 400). Each NVLink 410 provides a data transfer rate of 25 Gigabytes/second in each direction, with six links providing 400 Gigabytes/second. The NVLinks 410 can be used exclusively for PPU-to-PPU communication as shown in FIG. 5A, or some combination of PPU-to-PPU and PPU-to-CPU, when the CPU 530 also includes one or more NVLink 410 interfaces.

In an embodiment, the NVLink 410 allows direct load/store/atomic access from the CPU 530 to each PPU's 400 memory 404. In an embodiment, the NVLink 410 supports coherency operations, allowing data read from the memories 404 to be stored in the cache hierarchy of the CPU 530, reducing cache access latency for the CPU 530. In an embodiment, the NVLink 410 includes support for Address Translation Services (ATS), allowing the PPU 400 to directly access page tables within the CPU 530. One or more of the NVLinks 410 may also be configured to operate in a low-power mode.

FIG. 5B illustrates an exemplary system 565 in which the various architecture and/or functionality of the various previous embodiments may be implemented. The exemplary system 565 may be configured, e.g., to implement method 200 shown in FIG. 2A, method 210 shown in FIG. 2C, and/or method 230 shown in FIG. 2D.

As shown, a system 565 is provided including at least one central processing unit 530 that is connected to a communication bus 575. The communication bus 575 may directly or indirectly couple one or more of the following devices: main memory 540, network interface 535, CPU(s) 530, display device(s) 545, input device(s) 560, switch 510, and parallel processing system 525. The communication bus 575 may be implemented using any suitable protocol and may represent one or more links or busses, such as an address bus, a data bus, a control bus, or a combination thereof. The communication bus 575 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, HyperTransport, and/or another type of bus or link. In some embodiments, there are direct connections between components. As an example, the CPU(s) 530 may be directly connected to the main memory 540. Further, the CPU(s) 530 may be directly connected to the parallel processing system 525. Where there is direct, or point-to-point connection between components, the communication bus 575 may include a PCIe link to carry out the connection. In these examples, a PCI bus need not be included in the system 565.

Although the various blocks of FIG. 5C are shown as connected via the communication bus 575 with lines, this is not intended to be limiting and is for clarity only. For example, in some embodiments, a presentation component, such as display device(s) 545, may be considered an I/O component, such as input device(s) 560 (e.g., if the display is a touch screen). As another example, the CPU(s) 530 and/or parallel processing system 525 may include memory (e.g., the main memory 540 may be representative of a storage device in addition to the parallel processing system 525, the CPUs 530, and/or other components). In other words, the computing device of FIG. 5C is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5C.

The system 565 also includes a main memory 540. Control logic (software) and data are stored in the main memory 540 which may take the form of a variety of computer-readable media. The computer-readable media may be any available media that may be accessed by the system 565. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the main memory 540 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by system 565. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

Computer programs, when executed, enable the system 565 to perform various functions. The CPU(s) 530 may be configured to execute at least some of the computer-readable instructions to control one or more components of the system 565 to perform one or more of the methods and/or processes described herein. The CPU(s) 530 may each include one or more cores (e.g., one, two, four, eight, twenty-eight, seventy-two, etc.) that are capable of handling a multitude of software threads simultaneously. The CPU(s) 530 may include any type of processor, and may include different types of processors depending on the type of system 565 implemented (e.g., processors with fewer cores for mobile devices and processors with more cores for servers). For example, depending on the type of system 565, the processor may be an Advanced RISC Machines (ARM) processor implemented using Reduced Instruction Set Computing (RISC) or an x86 processor implemented using Complex Instruction Set Computing (CISC). The system 565 may include one or more CPUs 530 in addition to one or more microprocessors or supplementary co-processors, such as math co-processors.

In addition to or alternatively from the CPU(s) 530, the parallel processing module 525 may be configured to execute at least some of the computer-readable instructions to control one or more components of the system 565 to perform one or more of the methods and/or processes described herein. The parallel processing module 525 may be used by the system 565 to render graphics (e.g., 3D graphics) or perform general purpose computations. For example, the parallel processing module 525 may be used for General-Purpose computing on GPUs (GPGPU). In embodiments, the CPU(s) 530 and/or the parallel processing module 525 may discretely or jointly perform any combination of the methods, processes and/or portions thereof.

The system 565 also includes input device(s) 560, the parallel processing system 525, and display device(s) 545. The display device(s) 545 may include a display (e.g., a monitor, a touch screen, a television screen, a heads-up-display (HUD), other display types, or a combination thereof), speakers, and/or other presentation components. The display device(s) 545 may receive data from other components (e.g., the parallel processing system 525, the CPU(s) 530, etc.), and output the data (e.g., as an image, video, sound, etc.).

The network interface 535 may enable the system 565 to be logically coupled to other devices including the input devices 560, the display device(s) 545, and/or other components, some of which may be built in to (e.g., integrated in) the system 565. Illustrative input devices 560 include a microphone, mouse, keyboard, joystick, game pad, game controller, satellite dish, scanner, printer, wireless device, etc. The input devices 560 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the system 565. The system 565 may be include depth cameras, such as stereoscopic camera systems, infrared camera systems, RGB camera systems, touchscreen technology, and combinations of these, for gesture detection and recognition. Additionally, the system 565 may include accelerometers or gyroscopes (e.g., as part of an inertia measurement unit (IMU)) that enable detection of motion. In some examples, the output of the accelerometers or gyroscopes may be used by the system 565 to render immersive augmented reality or virtual reality.

Further, the system 565 may be coupled to a network (e.g., a telecommunications network, local area network (LAN), wireless network, wide area network (WAN) such as the Internet, peer-to-peer network, cable network, or the like) through a network interface 535 for communication purposes. The system 565 may be included within a distributed network and/or cloud computing environment.

The network interface 535 may include one or more receivers, transmitters, and/or transceivers that enable the system 565 to communicate with other computing devices via an electronic communication network, included wired and/or wireless communications. The network interface 535 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The system 565 may also include a secondary storage (not shown). The secondary storage 610 includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner. The system 565 may also include a hard-wired power supply, a battery power supply, or a combination thereof (not shown). The power supply may provide power to the system 565 to enable the components of the system 565 to operate.

Each of the foregoing modules and/or devices may even be situated on a single semiconductor platform to form the system 565. Alternately, the various modules may also be situated separately or in various combinations of semiconductor platforms per the desires of the user. While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the processing system 500 of FIG. 5A and/or exemplary system 565 of FIG. 5B—e.g., each device may include similar components, features, and/or functionality of the processing system 500 and/or exemplary system 565.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example processing system 500 of FIG. 5B and/or exemplary system 565 of FIG. 5C. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

### Machine Learning

Deep neural networks (DNNs) developed on processors, such as the PPU 400 have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions that are supported by the PPU 400. Inferencing is less compute-intensive than training, being a latency-sensitive process where a trained neural network is applied to new inputs it has not seen before to classify images, detect emotions, identify recommendations, recognize and translate speech, and generally infer new information.

Neural networks rely heavily on matrix math operations, and complex multi-layered networks require tremendous amounts of floating-point performance and bandwidth for both efficiency and speed. With thousands of processing cores, optimized for matrix math operations, and delivering tens to hundreds of TFLOPS of performance, the PPU 400 is a computing platform capable of delivering performance required for deep neural network-based artificial intelligence and machine learning applications.

Furthermore, images generated applying one or more of the techniques disclosed herein may be used to train, test, or certify DNNs used to recognize objects and environments in the real world. Such images may include scenes of roadways, factories, buildings, urban settings, rural settings, humans, animals, and any other physical object or real-world setting. Such images may be used to train, test, or certify DNNs that are employed in machines or robots to manipulate, handle, or modify physical objects in the real world. Furthermore, such images may be used to train, test, or certify DNNs that are employed in autonomous vehicles to navigate and move the vehicles through the real world. Additionally, images generated applying one or more of the techniques disclosed herein may be used to convey information to users of such machines, robots, and vehicles.

FIG. 5C illustrates components of an exemplary system 555 that can be used to train and utilize machine learning, in accordance with at least one embodiment. As will be discussed, various components can be provided by various combinations of computing devices and resources, or a single computing system, which may be under control of a single entity or multiple entities. Further, aspects may be triggered, initiated, or requested by different entities. In at least one embodiment training of a neural network might be instructed by a provider associated with provider environment 506, while in at least one embodiment training might be requested by a customer or other user having access to a provider environment through a client device 502 or other such resource. In at least one embodiment, training data (or data to be analyzed by a trained neural network) can be provided by a provider, a user, or a third party content provider 524. In at least one embodiment, client device 502 may be a vehicle or object that is to be navigated on behalf of a user, for example, which can submit requests and/or receive instructions that assist in navigation of a device.

In at least one embodiment, requests are able to be submitted across at least one network 504 to be received by a provider environment 506. In at least one embodiment, a client device may be any appropriate electronic and/or computing devices enabling a user to generate and send such requests, such as, but not limited to, desktop computers, notebook computers, computer servers, smartphones, tablet computers, gaming consoles (portable or otherwise), computer processors, computing logic, and set-top boxes. Network(s) 504 can include any appropriate network for transmitting a request or other such data, as may include Internet, an intranet, an Ethernet, a cellular network, a local area network (LAN), a wide area network (WAN), a personal area network (PAN), an ad hoc network of direct wireless connections among peers, and so on.

In at least one embodiment, requests can be received at an interface layer 508, which can forward data to a training and inference manager 532, in this example. The training and inference manager 532 can be a system or service including hardware and software for managing requests and service corresponding data or content, in at least one embodiment, the training and inference manager 532 can receive a request to train a neural network, and can provide data for a request to a training module 512. In at least one embodiment, training module 512 can select an appropriate model or neural network to be used, if not specified by the request, and can train a model using relevant training data. In at least one embodiment, training data can be a batch of data stored in a training data repository 514, received from client device 502, or obtained from a third party provider 524. In at least one embodiment, training module 512 can be responsible for training data. A neural network can be any appropriate network, such as a recurrent neural network (RNN) or convolutional neural network (CNN). Once a neural network is trained and successfully evaluated, a trained neural network can be stored in a model repository 516, for example, that may store different models or networks for users, applications, or services, etc. In at least one embodiment, there may be multiple models for a single application or entity, as may be utilized based on a number of different factors.

In at least one embodiment, at a subsequent point in time, a request may be received from client device 502 (or another such device) for content (e.g., path determinations) or data that is at least partially determined or impacted by a trained neural network. This request can include, for example, input data to be processed using a neural network to obtain one or more inferences or other output values, classifications, or predictions, or for at least one embodiment, input data can be received by interface layer 508 and directed to inference module 518, although a different system or service can be used as well. In at least one embodiment, inference module 518 can obtain an appropriate trained network, such as a trained deep neural network (DNN) as discussed herein, from model repository 516 if not already stored locally to inference module 518. Inference module 518 can provide data as input to a trained network, which can then generate one or more inferences as output. This may include, for example, a classification of an instance of input data. In at least one embodiment, inferences can then be transmitted to client device 502 for display or other communication to a user. In at least one embodiment, context data for a user may also be stored to a user context data repository 522, which may include data about a user which may be useful as input to a network in generating inferences, or determining data to return to a user after obtaining instances. In at least one embodiment, relevant data, which may include at least some of input or inference data, may also be stored to a local database 534 for processing future requests. In at least one embodiment, a user can use account information or other information to access resources or functionality of a provider environment. In at least one embodiment, if permitted and available, user data may also be collected and used to further train models, in order to provide more accurate inferences for future requests. In at least one embodiment, requests may be received through a user interface to a machine learning application 526 executing on client device 502, and results displayed through a same interface. A client device can include resources such as a processor 528 and memory 562 for generating a request and processing results or a response, as well as at least one data storage element 552 for storing data for machine learning application 526.

In at least one embodiment a processor 528 (or a processor of training module 512 or inference module 518) will be a central processing unit (CPU). As mentioned, however, resources in such environments can utilize GPUs to process data for at least certain types of requests. With thousands of cores, GPUs, such as PPU 300 are designed to handle substantial parallel workloads and, therefore, have become popular in deep learning for training neural networks and generating predictions. While use of GPUs for offline builds has enabled faster training of larger and more complex models, generating predictions offline implies that either request-time input features cannot be used or predictions must be generated for all permutations of features and stored in a lookup table to serve real-time requests. If a deep learning framework supports a CPU-mode and a model is small and simple enough to perform a feed-forward on a CPU with a reasonable latency, then a service on a CPU instance could host a model. In this case, training can be done offline on a GPU and inference done in real-time on a CPU. If a CPU approach is not viable, then a service can run on a GPU instance. Because GPUs have different performance and cost characteristics than CPUs, however, running a service that offloads a runtime algorithm to a GPU can require it to be designed differently from a CPU based service.

In at least one embodiment, video data can be provided from client device 502 for enhancement in provider environment 506. In at least one embodiment, video data can be processed for enhancement on client device 502. In at least one embodiment, video data may be streamed from a third party content provider 524 and enhanced by third party content provider 524, provider environment 506, or client device 502. In at least one embodiment, video data can be provided from client device 502 for use as training data in provider environment 506.

In at least one embodiment, supervised and/or unsupervised training can be performed by the client device 502 and/or the provider environment 506. In at least one embodiment, a set of training data 514 (e.g., classified or labeled data) is provided as input to function as training data.

In at least one embodiment, training data can include instances of at least one type of object for which a neural network is to be trained, as well as information that identifies that type of object. In at least one embodiment, training data might include a set of images that each includes a representation of a type of object, where each image also includes, or is associated with, a label, metadata, classification, or other piece of information identifying a type of object represented in a respective image. Various other types of data may be used as training data as well, as may include text data, audio data, video data, and so on. In at least one embodiment, training data 514 is provided as training input to a training module 512. In at least one embodiment, training module 512 can be a system or service that includes hardware and software, such as one or more computing devices executing a training application, for training a neural network (or other model or algorithm, etc.). In at least one embodiment, training module 512 receives an instruction or request indicating a type of model to be used for training, in at least one embodiment, a model can be any appropriate statistical model, network, or algorithm useful for such purposes, as may include an artificial neural network, deep learning algorithm, learning classifier, Bayesian network, and so on. In at least one embodiment, training module 512 can select an initial model, or other untrained model, from an appropriate repository 516 and utilize training data 514 to train a model, thereby generating a trained model (e.g., trained deep neural network) that can be used to classify similar types of data, or generate other such inferences. In at least one embodiment where training data is not used, an appropriate initial model can still be selected for training on input data per training module 512.

In at least one embodiment, a model can be trained in a number of different ways, as may depend in part upon a type of model selected. In at least one embodiment, a machine learning algorithm can be provided with a set of training data, where a model is a model artifact created by a training process. In at least one embodiment, each instance of training data contains a correct answer (e.g., classification), which can be referred to as a target or target attribute. In at least one embodiment, a learning algorithm finds patterns in training data that map input data attributes to a target, an answer to be predicted, and a machine learning model is output that captures these patterns. In at least one embodiment, a machine learning model can then be used to obtain predictions on new data for which a target is not specified.

In at least one embodiment, training and inference manager 532 can select from a set of machine learning models including binary classification, multiclass classification, generative, and regression models. In at least one embodiment, a type of model to be used can depend at least in part upon a type of target to be predicted.

### Graphics Processing Pipeline

In an embodiment, the PPU 400 comprises a graphics processing unit (GPU). The PPU 400 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The PPU 400 can be configured to process the graphics primitives to generate a frame buffer (e.g., pixel data for each of the pixels of the display).

An application writes model data for a scene (e.g., a collection of vertices and attributes) to a memory such as a system memory or memory 404. The model data defines each of the objects that may be visible on a display. The application then makes an API call to the driver kernel that requests the model data to be rendered and displayed. The driver kernel reads the model data and writes commands to the one or more streams to perform operations to process the model data. The commands may reference different shader programs to be implemented on the processing units within the PPU 400 including one or more of a vertex shader, hull shader, domain shader, geometry shader, and a pixel shader. For example, one or more of the processing units may be configured to execute a vertex shader program that processes a number of vertices defined by the model data. In an embodiment, the different processing units may be configured to execute different shader programs concurrently. For example, a first subset of processing units may be configured to execute a vertex shader program while a second subset of processing units may be configured to execute a pixel shader program. The first subset of processing units processes vertex data to produce processed vertex data and writes the processed vertex data to the L2 cache 460 and/or the memory 404. After the processed vertex data is rasterized (e.g., transformed from three-dimensional data into two-dimensional data in screen space) to produce fragment data, the second subset of processing units executes a pixel shader to produce processed fragment data, which is then blended with other processed fragment data and written to the frame buffer in memory 404. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

A graphics processing pipeline may be implemented via an application executed by a host processor, such as a CPU. In an embodiment, a device driver may implement an application programming interface (API) that defines various functions that can be utilized by an application in order to generate graphical data for display. The device driver is a software program that includes a plurality of instructions that control the operation of the PPU 400. The API provides an abstraction for a programmer that lets a programmer utilize specialized graphics hardware, such as the PPU 400, to generate the graphical data without requiring the programmer to utilize the specific instruction set for the PPU 400. The application may include an API call that is routed to the device driver for the PPU 400. The device driver interprets the API call and performs various operations to respond to the API call. In some instances, the device driver may perform operations by executing instructions on the CPU. In other instances, the device driver may perform operations, at least in part, by launching operations on the PPU 400 utilizing an input/output interface between the CPU and the PPU 400. In an embodiment, the device driver is configured to implement the graphics processing pipeline utilizing the hardware of the PPU 400.

Various programs may be executed within the PPU 400 in order to implement the various stages of the graphics processing pipeline. For example, the device driver may launch a kernel on the PPU 400 to perform a vertex shading stage on one processing unit (or multiple processing units). The device driver (or the initial kernel executed by the PPU 400) may also launch other kernels on the PPU 400 to perform other stages of the graphics processing pipeline, such as a geometry shading stage and a fragment shading stage. In addition, some of the stages of the graphics processing pipeline may be implemented on fixed unit hardware such as a rasterizer or a data assembler implemented within the PPU 400. It will be appreciated that results from one kernel may be processed by one or more intervening fixed function hardware units before being processed by a subsequent kernel on a processing unit.

Images generated applying one or more of the techniques disclosed herein may be displayed on a monitor or other display device. In some embodiments, the display device may be coupled directly to the system or processor generating or rendering the images. In other embodiments, the display device may be coupled indirectly to the system or processor such as via a network. Examples of such networks include the Internet, mobile telecommunications networks, a WIFI network, as well as any other wired and/or wireless networking system. When the display device is indirectly coupled, the images generated by the system or processor may be streamed over the network to the display device. Such streaming allows, for example, video games or other applications, which render images, to be executed on a server, a data center, or in a cloud-based computing environment and the rendered images to be transmitted and displayed on one or more user devices (such as a computer, video game console, smartphone, other mobile device, etc.) that are physically separate from the server or data center. Hence, the techniques disclosed herein can be applied to enhance the images that are streamed and to enhance services that stream images such as NVIDIA Geforce Now (GFN), Google Stadia, and the like.

### Example Streaming System

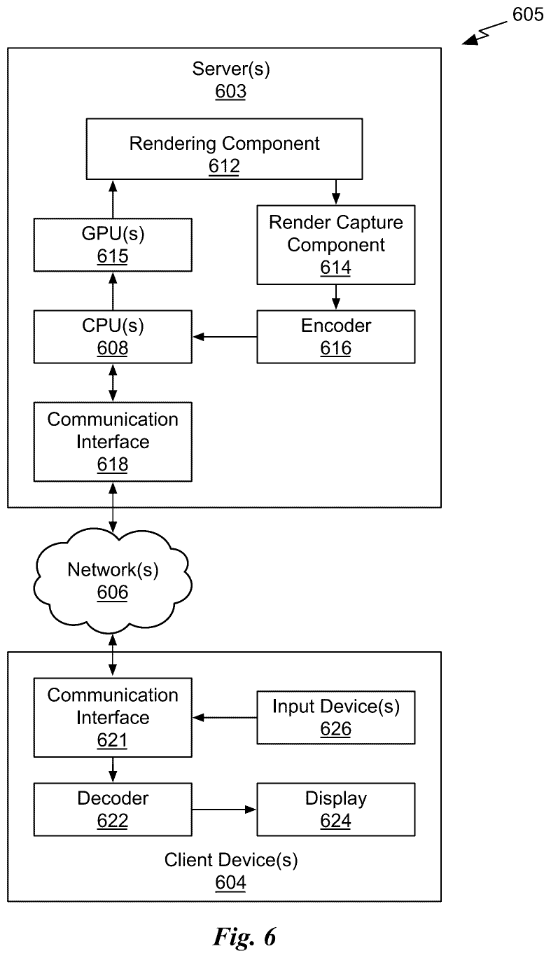

FIG. 6 is an example system diagram for a streaming system 605, in accordance with some embodiments of the present disclosure. FIG. 6 includes server(s) 603 (which may include similar components, features, and/or functionality to the example processing system 500 of FIG. 5A and/or exemplary system 565 of FIG. 5B), client device(s) 604 (which may include similar components, features, and/or functionality to the example processing system 500 of FIG. 5A and/or exemplary system 565 of FIG. 5B), and network(s) 606 (which may be similar to the network(s) described herein). In some embodiments of the present disclosure, the system 605 may be implemented.

In an embodiment, the streaming system 605 is a game streaming system and the server(s) 603 are game server(s). In the system 605, for a game session, the client device(s) 604 may only receive input data in response to inputs to the input device(s) 626, transmit the input data to the server(s) 603, receive encoded display data from the server(s) 603, and display the display data on the display 624. As such, the more computationally intense computing and processing is offloaded to the server(s) 603 (e.g., rendering—in particular ray or path tracing—for graphical output of the game session is executed by the GPU(s) 615 of the server(s) 603). In other words, the game session is streamed to the client device(s) 604 from the server(s) 603, thereby reducing the requirements of the client device(s) 604 for graphics processing and rendering.

For example, with respect to an instantiation of a game session, a client device 604 may be displaying a frame of the game session on the display 624 based on receiving the display data from the server(s) 603. The client device 604 may receive an input to one of the input device(s) 626 and generate input data in response. The client device 604 may transmit the input data to the server(s) 603 via the communication interface 621 and over the network(s) 606 (e.g., the Internet), and the server(s) 603 may receive the input data via the communication interface 618. The CPU(s) 608 may receive the input data, process the input data, and transmit data to the GPU(s) 615 that causes the GPU(s) 615 to generate a rendering of the game session. For example, the input data may be representative of a movement of a character of the user in a game, firing a weapon, reloading, passing a ball, turning a vehicle, etc. The rendering component 612 may render the game session (e.g., representative of the result of the input data) and the render capture component 614 may capture the rendering of the game session as display data (e.g., as image data capturing the rendered frame of the game session). The rendering of the game session may include ray or path-traced lighting and/or shadow effects, computed using one or more parallel processing units—such as GPUs, which may further employ the use of one or more dedicated hardware accelerators or processing cores to perform ray or path-tracing techniques—of the server(s) 603. The encoder 616 may then encode the display data to generate encoded display data and the encoded display data may be transmitted to the client device 604 over the network(s) 606 via the communication interface 618. The client device 604 may receive the encoded display data via the communication interface 621 and the decoder 622 may decode the encoded display data to generate the display data. The client device 604 may then display the display data via the display 624.

It is noted that the techniques described herein may be embodied in executable instructions stored in a computer readable medium for use by or in connection with a processor-based instruction execution machine, system, apparatus, or device. It will be appreciated by those skilled in the art that, for some embodiments, various types of computer-readable media can be included for storing data. As used herein, a “computer-readable medium” includes one or more of any suitable media for storing the executable instructions of a computer program such that the instruction execution machine, system, apparatus, or device may read (or fetch) the instructions from the computer-readable medium and execute the instructions for carrying out the described embodiments. Suitable storage formats include one or more of an electronic, magnetic, optical, and electromagnetic format. A non-exhaustive list of conventional exemplary computer-readable medium includes: a portable computer diskette; a random-access memory (RAM); a read-only memory (ROM); an erasable programmable read only memory (EPROM); a flash memory device; and optical storage devices, including a portable compact disc (CD), a portable digital video disc (DVD), and the like.

It should be understood that the arrangement of components illustrated in the attached Figures are for illustrative purposes and that other arrangements are possible. For example, one or more of the elements described herein may be realized, in whole or in part, as an electronic hardware component. Other elements may be implemented in software, hardware, or a combination of software and hardware. Moreover, some or all of these other elements may be combined, some may be omitted altogether, and additional components may be added while still achieving the functionality described herein. Thus, the subject matter described herein may be embodied in many different variations, and all such variations are contemplated to be within the scope of the claims.

To facilitate an understanding of the subject matter described herein, many aspects are described in terms of sequences of actions. It will be recognized by those skilled in the art that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar references in the context of describing the subject matter (particularly in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Furthermore, the foregoing description is for the purpose of illustration only, and not for the purpose of limitation, as the scope of protection sought is defined by the claims as set forth hereinafter together with any equivalents thereof. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

What is claimed is:

1. A system, comprising:
one or more processors to use one or more neural networks to generate a sequence of tokens that represent vertex coordinates of a 3D mesh based, at least in part, on one or more three-dimensional representations of one or more objects; and
one or more memories to store the one or more neural networks,
wherein the 3D mesh comprises one or more parts, and
wherein the sequence of tokens includes a set of start-of-part tokens and a set of end-of-part tokens that, respectively, designate a start and an end of a set of tokens that represent vertex coordinates of a respective part of the one or more parts.

2. The system of claim 1, wherein the one or more three-dimensional representations of the one or more objects are one or more of a point cloud, a three-dimensional mesh, Neural Radiance Fields (NeRF), Signed Distance Function (SDF) and a gaussian 3D models.

3. The system of claim 2, wherein the one or more neural networks comprise an Hourglass Transformer backbone.

4. The system of claim 3, wherein the Hourglass Transformer backbone comprises a plurality of transformer stacks, one or more shortening layers, and one or more upsampling layers.

5. The system of claim 4, wherein the sequence of tokens has a length of N, wherein the 3D mesh is formed of a plurality of n-dimensional polygons, wherein a first shortening layer is configured to reduce a sequence length of a first token sequence processed by a corresponding transformer stack from 3nN to 3N, and wherein a second shortening layer is configured to reduce a sequence length of a second token sequence processed by a corresponding transformer stack from 3N to N.

6. The system of claim 4, wherein a first transformer stack of the plurality of transformer stacks is configured to process vertex coordinate tokens that each designate a coordinate of a vertex of a polygon of the 3D mesh, wherein a second transformer stack of the plurality of transformer stacks is configured to process vertex tokens that each designate a vertex of a polygon of the 3D mesh, and wherein a third transformer stack of the plurality of transformer stacks is configured to process polygon tokens that each represent a polygon of the 3D mesh.

7. The system of claim 4, wherein each transformer stack is configured to receive a conditional embedding corresponding to the one or more three-dimensional representations of the one or more objects.

8. The system of claim 7, wherein the conditional embedding received by each respective transformer stack is provided to at least one cross-attention layer of the respective transformer stack.

9. A method for generating, by one or more neural networks, a sequence of tokens that represent vertices of a 3D mesh based, at least in part, on one or more three-dimensional representations of one or more objects, the method comprising:
generating, for each respective part of one or more parts of the one or more objects, a respective token sequence, each respective token sequence comprising one or more start-of-part tokens, one or more vertex coordinate tokens, and one or more end-of-part tokens,
wherein each of the one or more vertex coordinate tokens represents a coordinate of a vertex of the respective part.

10. The method according to claim 9, wherein the one or more neural networks comprise an Hourglass Transformer backbone comprising a plurality of transformer stacks, one or more shortening layers, and one or more upsampling layers.

11. A system, comprising:
one or more processors to use one or more neural networks to generate a sequence of tokens that represent vertex coordinates of a 3D mesh based, at least in part, on one or more three-dimensional representations of one or more objects; and
one or more memories to store the one or more neural networks,
wherein the one or more neural networks are trained via a progressive training process comprising:
providing a pretrained transformer backbone;
expanding one or more parameter blocks of the pretrained transformer backbone to provide an expanded transformer backbone; and
fine-tuning the expanded transformer backbone to provide the one or more neural networks.

12. The system of claim 11, wherein the pretrained transformer backbone is an Hourglass Transformer backbone.

13. The system of claim 12, wherein expanding the one or more parameter blocks of the pretrained transformer backbone comprises expanding a weight matrix of a final linear layer of the pretrained transformer backbone, the final linear layer being configured to project embeddings in a hidden space of transformer blocks of the pretrained transformer backbone into a logits space.

14. The system of claim 13, the progressive training further comprising initializing one or more weights of the expanded transformer backbone with weights of the pretrained transformer backbone.

15. The system of claim 12, wherein the one or more three-dimensional representations include one or more of a point cloud, a 3D mesh, a Neural Radiance Fields (NeRF), a Signed Distance Function (SDF), or a 3D Gaussian model.

16. The system of claim 12, wherein the Hourglass Transformer backbone comprises a plurality of transformer stacks, one or more shortening layers, and one or more upsampling layers.

17. The system of claim 16, wherein the sequence of tokens has a length of N, wherein the 3D mesh is formed of a plurality of n-dimensional polygons, wherein a first shortening layer is configured to reduce a sequence length of a first token sequence processed by a corresponding transformer stack from 3nN to 3N, and wherein a second shortening layer is configured to reduce a sequence length of a second token sequence processed by a corresponding transformer stack from 3N to N.

18. The system of claim 16, wherein a first transformer stack of the plurality of transformer stacks is configured to process vertex coordinate tokens that each designate a coordinate of a vertex of a polygon of the 3D mesh, wherein a second transformer stack of the plurality of transformer stacks is configured to process vertex tokens that each designate a vertex of a polygon of the 3D mesh, and wherein a third transformer stack of the plurality of transformer stacks is configured to process polygon tokens that each represent a polygon of the 3D mesh.

19. A method for training one or more neural networks to generate a sequence of tokens that represent vertices of a 3D mesh based, at least in part, on one or more three-dimensional representations of one or more objects, the method comprising:
providing a pretrained transformer backbone;
expanding one or more parameter blocks of the pretrained transformer backbone to provide an expanded transformer backbone; and
fine-tuning the expanded transformer backbone to provide the one or more neural networks.

20. The method according to claim 19, wherein the one or more neural networks comprise an Hourglass Transformer backbone comprising a plurality of transformer stacks, one or more shortening layers, and one or more upsampling layers.
